(19) United States
(12) Patent Application Publication
(10) Pub. No.: US 2026/0051765 A1
(43) Pub. Date: Feb. 19, 2026

(54) TECHNIQUES FOR ENERGY TRANSFER DEVICES SUPPORTING MULTIPLE TYPES OF WIRELESS ENERGY TRANSFER

(71) Applicant: QUALCOMM INCORPORATED, San Diego, CA (US)

(72) Inventors: Ahmed Elshafie, San Diego, CA (US); Yuchul Kim, San Diego, CA (US); Zhikun Wu, Beijing (CN); Linhai He, San Diego, CA (US); Huilin Xu, Temecula, CA (US); Krishna Kiran Mukkavilli, San Diego, CA (US); Tingfang Ji, San Diego, CA (US)

(21) Appl. No.: 19/102,364

(22) PCT Filed: Sep. 16, 2022
(86) PCT No.: PCT/CN2022/119289

§ 371 Date: Feb. 7, 2025

(51) Int. Cl. H02J 50/00; H02J 50/20; H02J 50/30; H02J 50/80

(52) U.S. Cl. CPC H02J 50/001; H02J 50/20; H02J 50/30; H02J 50/80

(57) ABSTRACT

Methods, systems, and devices for wireless communications are described. An energy-harvesting device may receive capability or control signaling from an energy-providing device indicating multiple energy-harvesting procedures that are supported by the energy-providing device (e.g., radio frequency-based energy-harvesting, light-based energy harvesting, etc.). The energy-harvesting device may then transmit additional capability or control signaling indicating which of the supported energy-harvesting procedures are also supported by the energy-harvesting device. Subsequently, the energy-harvesting device may receive an energy signal from the energy-providing device in accordance with an energy-harvesting procedure that is supported by both respective devices.

### CROSS REFERENCE

This application is a 371 National Stage of PCT Application No. PCT/CN2022/119289, filed on Sep. 16, 2022, entitled “TECHNIQUES FOR ENERGY TRANSFER DEVICES SUPPORTING MULTIPLE TYPES OF WIRELESS ENERGY TRANSFER,” and assigned to the assignee hereof. The disclosure of the prior Application is considered part of and is incorporated by reference into this patent application.

### FIELD OF TECHNOLOGY

The following relates to wireless communications, including techniques for energy transfer devices supporting multiple types of wireless energy transfer.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems and possibly future generations. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications systems include energy-harvesting devices, such as UEs or radio frequency (RF) identifier (RFID) tags, that are able to wirelessly harvest energy that may be used by the respective devices to perform wireless communications or perform other operations.

### SUMMARY

The described techniques relate to improved methods, systems, devices, and apparatuses that support techniques for energy transfer devices supporting multiple types of wireless energy transfer. For the purposes of the present disclosure, the “energy transfer devices” may be used to refer to wireless devices that are capable of transmitting signals that are used for wireless energy harvesting (e.g., “energy-providing devices”), wireless devices that are capable of generating energy using received signals (e.g., “energy-harvesting devices”), or both. Generally, aspects of the present disclosure are directed to two-way capability signaling that can be exchanged between energy-harvesting and energy-providing devices so that the devices may efficiently perform energy-harvesting procedures that are supported by the other respective devices. For example, an energy-providing device may indicate a set of supported energy-harvesting procedures/sources, and an energy-harvesting device may indicate which of the set of supported energy-harvesting procedures/sources that are also supported by the energy-harvesting device. Subsequently, the energy-providing devices and energy-harvesting devices may be able to perform an energy-harvesting procedure that is supported by both of the respective devices.

A method for wireless communication at an energy-harvesting wireless device is described. The method includes communicating, with an energy-providing wireless device, first control signaling indicating a set of multiple energy-harvesting procedures supported by the energy-providing wireless device or the energy-harvesting wireless device, communicating, with the energy-providing wireless device based on the first control signaling, second control signaling indicating at least one energy-harvesting procedure supported by the energy-providing wireless device and the energy-harvesting wireless device, the at least one energy-harvesting procedure included within the set of multiple energy-harvesting procedures, and receiving, from the energy-providing wireless device, an energy signal associated with the at least one energy-harvesting procedure.

An apparatus for wireless communication at an energy-harvesting wireless device is described. The apparatus includes a processor, memory coupled with the processor, and instructions stored in the memory. The instructions may be executable by the processor to cause the apparatus to communicate, with an energy-providing wireless device, first control signaling indicating a set of multiple energy-harvesting procedures supported by the energy-providing wireless device or the energy-harvesting wireless device, communicate, with the energy-providing wireless device based on the first control signaling, second control signaling indicating at least one energy-harvesting procedure supported by the energy-providing wireless device and the energy-harvesting wireless device, the at least one energy-harvesting procedure included within the set of multiple energy-harvesting procedures, and receive, from the energy-providing wireless device, an energy signal associated with the at least one energy-harvesting procedure.

Another apparatus for wireless communication at an energy-harvesting wireless device is described. The apparatus includes means for communicating, with an energy-providing wireless device, first control signaling indicating a set of multiple energy-harvesting procedures supported by the energy-providing wireless device or the energy-harvesting wireless device, means for communicating, with the energy-providing wireless device based on the first control signaling, second control signaling indicating at least one energy-harvesting procedure supported by the energy-providing wireless device and the energy-harvesting wireless device, the at least one energy-harvesting procedure included within the set of multiple energy-harvesting procedures, and means for receiving, from the energy-providing wireless device, an energy signal associated with the at least one energy-harvesting procedure.

A non-transitory computer-readable medium storing code for wireless communication at an energy-harvesting wireless device is described. The code may include instructions executable by a processor to communicate, with an energy-providing wireless device, first control signaling indicating a set of multiple energy-harvesting procedures supported by the energy-providing wireless device or the energy-harvesting wireless device, communicate, with the energy-providing wireless device based on the first control signaling, second control signaling indicating at least one energy-harvesting procedure supported by the energy-providing wireless device and the energy-harvesting wireless device, the at least one energy-harvesting procedure included within the set of multiple energy-harvesting procedures, and receive, from the energy-providing wireless device, an energy signal associated with the at least one energy-harvesting procedure.

Some examples of the method, apparatuses, and non-transitory computer-readable medium described herein may further include operations, features, means, or instructions for communicating, with the energy-providing wireless device, the first control signaling indicating an energy-harvesting pattern associated with the energy-providing wireless device or the energy-harvesting wireless device, where the energy signal may be received within a time interval of a set of multiple time intervals of the energy-harvesting pattern.

Some examples of the method, apparatuses, and non-transitory computer-readable medium described herein may further include operations, features, means, or instructions for transmitting, to the energy-providing wireless device, the first control signaling indicating one or more parameters associated with at least one of the set of multiple energy-harvesting procedures supported by the energy-harvesting wireless device, the one or more parameters indicating an energy efficiency, a charging rate, or both, where the second control signaling may be received based on the one or more parameters.

Some examples of the method, apparatuses, and non-transitory computer-readable medium described herein may further include operations, features, means, or instructions for receiving, from the energy-providing wireless device, the second control signaling or additional control signaling indicating a set of resources usable for performing the at least one energy-harvesting procedure, where the energy signal may be received within the set of resources.

Some examples of the method, apparatuses, and non-transitory computer-readable medium described herein may further include operations, features, means, or instructions for receiving, from the energy-providing wireless device, the second control signaling or additional control signaling indicating a quasi co-location (QCL) indicator, a transmission configuration indicator (TCI) state, a transmission-reception point (TRP) associated with the energy-providing wireless device, or any combination thereof, where receiving the energy signal may be based on the QCL indicator, the TCI state, the TRP, or any combination thereof.

Some examples of the method, apparatuses, and non-transitory computer-readable medium described herein may further include operations, features, means, or instructions for receiving a first QCL indicator and a second QCL indicator associated with a first TRP and a second TRP, respectively, associated with the energy-providing wireless device, receiving the energy signal associated with the at least one energy-harvesting procedure via the first TRP and in accordance with the first QCL indicator, and receiving an additional energy signal associated with the at least one energy-harvesting procedure via the second TRP and in accordance with the second QCL indicator.

Some examples of the method, apparatuses, and non-transitory computer-readable medium described herein may further include operations, features, means, or instructions for communicating, with the energy-providing wireless device, a request for the set of multiple energy-harvesting procedures supported by the energy-providing wireless device or the energy-harvesting wireless device, where communicating the first control signaling, the second control signaling, or both, may be based on the request.

In some examples of the method, apparatuses, and non-transitory computer-readable medium described herein, the energy signal may be received during a first time interval and the method, apparatuses, and non-transitory computer-readable medium may include further operations, features, means, or instructions for communicating, with the energy-providing wireless device, a capability indication that the energy-harvesting wireless device may be capable of performing multiple temporally-overlapping energy-harvesting procedures and receiving, from the energy-providing wireless device, a second energy signal associated with an additional energy-harvesting procedure based on the capability indication, where the second energy signal may be received during a second time interval that at least partially overlaps in a time domain with the first time interval.

Some examples of the method, apparatuses, and non-transitory computer-readable medium described herein may further include operations, features, means, or instructions for transmitting, to the energy-providing wireless device based on receiving the energy signal, a report indicating one or more parameters associated with the at least one energy-harvesting procedure.

Some examples of the method, apparatuses, and non-transitory computer-readable medium described herein may further include operations, features, means, or instructions for receiving, from the energy-providing wireless device, a reporting configuration for transmitting reports associated with energy-harvesting procedures, where the report may be transmitted in accordance with the reporting configuration.

Some examples of the method, apparatuses, and non-transitory computer-readable medium described herein may further include operations, features, means, or instructions for receiving, from the energy-providing wireless device based on transmitting the report, an instruction to selectively adjust one or more reception parameters for receiving energy signals associated with the at least one energy-harvesting procedure and receiving an additional energy signal associated with the at least one energy-harvesting procedure based on the instruction.

Some examples of the method, apparatuses, and non-transitory computer-readable medium described herein may further include operations, features, means, or instructions for receiving additional control signaling indicating a set of multiple energy-harvesting types, where each energy-harvesting type supports a respective set of energy-harvesting procedures and communicating, via the first control signaling, an indication of an energy-harvesting type associated with the energy-harvesting wireless device, where communicating the second control signaling, receiving the energy signal, or both, may be based on the energy-harvesting type.

Some examples of the method, apparatuses, and non-transitory computer-readable medium described herein may further include operations, features, means, or instructions for communicating, with the energy-providing wireless device, third control signaling indicating that one or more energy-harvesting procedures of the set of multiple energy-harvesting procedures may be no longer supported by the energy-providing wireless device or the energy-harvesting wireless device for a time interval.

Some examples of the method, apparatuses, and non-transitory computer-readable medium described herein may further include operations, features, means, or instructions for transmitting, to the energy-providing wireless device, the first control signaling indicating the set of multiple energy-harvesting procedures supported by the energy-harvesting wireless device and receiving, from the energy-providing wireless device, the second control signaling indicating the at least one energy-harvesting procedure supported by the energy-providing wireless device.

Some examples of the method, apparatuses, and non-transitory computer-readable medium described herein may further include operations, features, means, or instructions for receiving, from the energy-providing wireless device, the first control signaling indicating the set of multiple energy-harvesting procedures supported by the energy-providing wireless device and transmitting, to the energy-providing wireless device, the second control signaling indicating the at least one energy-harvesting procedure supported by the energy-harvesting wireless device.

In some examples of the method, apparatuses, and non-transitory computer-readable medium described herein, the set of multiple energy-harvesting procedures include a first energy-harvesting procedure and a second energy-harvesting procedure and the method, apparatuses, and non-transitory computer-readable medium may include further operations, features, means, or instructions for transmitting, to the energy-harvesting wireless device via the first control signaling or the second control signaling, a first energy storage capacity associated with the first energy-harvesting procedure, a second energy storage capacity associated with the second energy-harvesting procedure, a third energy storage capacity associated with both the first energy-harvesting procedure and the second energy-harvesting procedure, or any combination thereof, where receiving the energy signal may be based on the first energy storage capacity, the second energy storage capacity, the third energy storage capacity, or any combination thereof.

Some examples of the method, apparatuses, and non-transitory computer-readable medium described herein may further include operations, features, means, or instructions for receiving a wake-up signal (WUS) from the energy-providing wireless device, where receiving the energy signal may be based on receiving the WUS.

Some examples of the method, apparatuses, and non-transitory computer-readable medium described herein may further include operations, features, means, or instructions for generating energy based on receiving the energy signal and performing one or more communications or other operations using the generated energy, storing the generated energy in an energy storage component, or both.

In some examples of the method, apparatuses, and non-transitory computer-readable medium described herein, the set of multiple energy-harvesting procedures includes an RF (RF)-based energy-harvesting procedure, a light-based energy-harvesting procedure, a motion-based energy-harvesting procedure, a heat-based energy-harvesting procedure, or any combination thereof.

In some examples of the method, apparatuses, and non-transitory computer-readable medium described herein, the energy-harvesting wireless device includes a user equipment (UE) and the energy-providing wireless device includes a network entity.

A method for wireless communication at an energy-providing wireless device is described. The method includes communicating, with an energy-harvesting wireless device, first control signaling indicating a set of multiple energy-harvesting procedures supported by the energy-providing wireless device or the energy-harvesting wireless device, communicating, with the energy-harvesting wireless device based on the first control signaling, second control signaling indicating at least one energy-harvesting procedure supported by the energy-providing wireless device and the energy-harvesting wireless device, the at least one energy-harvesting procedure included within the set of multiple energy-harvesting procedures, and transmitting, to the energy-harvesting wireless device, an energy signal associated with the at least one energy-harvesting procedure.

An apparatus for wireless communication at an energy-providing wireless device is described. The apparatus includes a processor, memory coupled with the processor, and instructions stored in the memory. The instructions may be executable by the processor to cause the apparatus to communicate, with an energy-harvesting wireless device, first control signaling indicating a set of multiple energy-harvesting procedures supported by the energy-providing wireless device or the energy-harvesting wireless device, communicate, with the energy-harvesting wireless device based on the first control signaling, second control signaling indicating at least one energy-harvesting procedure supported by the energy-providing wireless device and the energy-harvesting wireless device, the at least one energy-harvesting procedure included within the set of multiple energy-harvesting procedures, and transmit, to the energy-harvesting wireless device, an energy signal associated with the at least one energy-harvesting procedure.

Another apparatus for wireless communication at an energy-providing wireless device is described. The apparatus includes means for communicating, with an energy-harvesting wireless device, first control signaling indicating a set of multiple energy-harvesting procedures supported by the energy-providing wireless device or the energy-harvesting wireless device, means for communicating, with the energy-harvesting wireless device based on the first control signaling, second control signaling indicating at least one energy-harvesting procedure supported by the energy-providing wireless device and the energy-harvesting wireless device, the at least one energy-harvesting procedure included within the set of multiple energy-harvesting procedures, and means for transmitting, to the energy-harvesting wireless device, an energy signal associated with the at least one energy-harvesting procedure.

A non-transitory computer-readable medium storing code for wireless communication at an energy-providing wireless device is described. The code may include instructions executable by a processor to communicate, with an energy-harvesting wireless device, first control signaling indicating a set of multiple energy-harvesting procedures supported by the energy-providing wireless device or the energy-harvesting wireless device, communicate, with the energy-harvesting wireless device based on the first control signaling, second control signaling indicating at least one energy-harvesting procedure supported by the energy-providing wireless device and the energy-harvesting wireless device, the at least one energy-harvesting procedure included within the set of multiple energy-harvesting procedures, and transmit, to the energy-harvesting wireless device, an energy signal associated with the at least one energy-harvesting procedure.

Some examples of the method, apparatuses, and non-transitory computer-readable medium described herein may further include operations, features, means, or instructions for communicating, with the energy-harvesting wireless device, the first control signaling indicating an energy-harvesting pattern associated with the energy-providing wireless device or the energy-harvesting wireless device, where the energy signal may be transmitted within a time interval of a set of multiple time intervals of the energy-harvesting pattern.

Some examples of the method, apparatuses, and non-transitory computer-readable medium described herein may further include operations, features, means, or instructions for receiving, from the energy-harvesting wireless device, the first control signaling indicating one or more parameters associated with at least one of the set of multiple energy-harvesting procedures supported by the energy-harvesting wireless device, the one or more parameters indicating an energy efficiency, a charging rate, or both and selecting the at least one energy-harvesting procedure from the set of multiple energy-harvesting procedures based on the one or more parameters, where the second control signaling may be transmitted based on the selecting.

Some examples of the method, apparatuses, and non-transitory computer-readable medium described herein may further include operations, features, means, or instructions for transmitting, to the energy-harvesting wireless device, the second control signaling or additional control signaling indicating a set of resources usable for performing the at least one energy-harvesting procedure, where the energy signal may be transmitted within the set of resources.

Some examples of the method, apparatuses, and non-transitory computer-readable medium described herein may further include operations, features, means, or instructions for transmitting, to the energy-harvesting wireless device, the second control signaling or additional control signaling indicating a QCL indicator, a TCI state, a TRP associated with the energy-providing wireless device, or any combination thereof, where transmitting the energy signal may be based on the QCL indicator, the TCI state, the TRP, or any combination thereof.

Some examples of the method, apparatuses, and non-transitory computer-readable medium described herein may further include operations, features, means, or instructions for communicating, with the energy-harvesting wireless device, a request for the set of multiple energy-harvesting procedures supported by the energy-providing wireless device or the energy-harvesting wireless device, where communicating the first control signaling, the second control signaling, or both, may be based on the request.

In some examples of the method, apparatuses, and non-transitory computer-readable medium described herein, the energy signal may be transmitted during a first time interval and the method, apparatuses, and non-transitory computer-readable medium may include further operations, features, means, or instructions for communicating, with the energy-harvesting wireless device, a capability indication that the energy-harvesting wireless device may be capable of performing multiple temporally-overlapping energy-harvesting procedures and transmitting, to the energy-harvesting wireless device, a second energy signal associated with an additional energy-harvesting procedure based on the capability indication, where the second energy signal may be transmitted during a second time interval that at least partially overlaps in a time domain with the first time interval.

Some examples of the method, apparatuses, and non-transitory computer-readable medium described herein may further include operations, features, means, or instructions for receiving, from the energy-harvesting wireless device based on transmitting the energy signal, a report indicating one or more parameters associated with the at least one energy-harvesting procedure.

Some examples of the method, apparatuses, and non-transitory computer-readable medium described herein may further include operations, features, means, or instructions for transmitting, to the energy-harvesting wireless device, a reporting configuration for transmitting reports associated with energy-harvesting procedures, where the report may be received in accordance with the reporting configuration.

Some examples of the method, apparatuses, and non-transitory computer-readable medium described herein may further include operations, features, means, or instructions for transmitting, to the energy-harvesting wireless device based on receiving the report, an instruction to selectively adjust one or more reception parameters for receiving energy signals associated with the at least one energy-harvesting procedure and transmitting an additional energy signal associated with the at least one energy-harvesting procedure based on the instruction.

In some examples of the method, apparatuses, and non-transitory computer-readable medium described herein, selectively adjusting one or more transmission parameters for transmitting energy signals based on the report and transmitting an additional energy signal associated with the at least one energy-harvesting procedure based on selectively adjusting the one or more transmission parameters.

Some examples of the method, apparatuses, and non-transitory computer-readable medium described herein may further include operations, features, means, or instructions for communicating, with the energy-harvesting wireless device, third control signaling indicating that one or more energy-harvesting procedures of the set of multiple energy-harvesting procedures may be no longer supported by the energy-providing wireless device or the energy-harvesting wireless device for a time interval.

Some examples of the method, apparatuses, and non-transitory computer-readable medium described herein may further include operations, features, means, or instructions for transmitting a WUS to the energy-harvesting wireless device, where transmitting the energy signal may be based on transmitting the WUS.

In some examples of the method, apparatuses, and non-transitory computer-readable medium described herein, the set of multiple energy-harvesting procedures includes an RF-based energy-harvesting procedure, a light-based energy-harvesting procedure, a motion-based energy-harvesting procedure, a heat-based energy-harvesting procedure, or any combination thereof.

In some examples of the method, apparatuses, and non-transitory computer-readable medium described herein, the energy-harvesting wireless device includes a UE and the energy-providing wireless device includes a network entity.

### BRIEF DESCRIPTION OF THE DRAWINGS

FIG. 1 illustrates an example of a wireless communications system that supports techniques for energy transfer devices supporting multiple types of wireless energy transfer in accordance with one or more aspects of the present disclosure.

FIG. 2 illustrates an example of a wireless communications system that supports techniques for energy transfer devices supporting multiple types of wireless energy transfer in accordance with one or more aspects of the present disclosure.

FIG. 3 illustrates an example of a process flow that supports techniques for energy transfer devices supporting multiple types of wireless energy transfer in accordance with one or more aspects of the present disclosure.

FIGS. 4 and 5 show diagrams of devices that support techniques for energy transfer devices supporting multiple types of wireless energy transfer in accordance with one or more aspects of the present disclosure.

FIG. 6 shows a diagram of a communications manager that supports techniques for energy transfer devices supporting multiple types of wireless energy transfer in accordance with one or more aspects of the present disclosure.

FIG. 7 shows a diagram of a system including a device that supports techniques for energy transfer devices supporting multiple types of wireless energy transfer in accordance with one or more aspects of the present disclosure.

FIGS. 8 and 9 show diagrams of devices that support techniques for energy transfer devices supporting multiple types of wireless energy transfer in accordance with one or more aspects of the present disclosure.

FIG. 10 shows a diagram of a communications manager that supports techniques for energy transfer devices supporting multiple types of wireless energy transfer in accordance with one or more aspects of the present disclosure.

FIG. 11 shows a diagram of a system including a device that supports techniques for energy transfer devices supporting multiple types of wireless energy transfer in accordance with one or more aspects of the present disclosure.

FIGS. 12 through 15 show flowcharts illustrating methods that support techniques for energy transfer devices supporting multiple types of wireless energy transfer in accordance with one or more aspects of the present disclosure.

### DETAILED DESCRIPTION

Some wireless communications systems include energy-harvesting devices, such as user equipments (UEs) or radio frequency (RF) identifier (RFID) tags, that are able to wirelessly harvest energy that may be used by the respective devices to perform wireless communications or perform other operations. Energy-harvesting and energy-providing devices may support different types/sources of energy-harvesting. For the purposes of the present disclosure, the terms “energy-providing devices” and “energy-harvesting devices” may generally be referred to as “energy transfer devices.” For example, a base station may be able to transmit both RF signals and laser energy to support RF-based and light-based energy-harvesting procedures. Comparatively, a UE may only be able to extract or generate energy from RF signals to support RF-based energy-harvesting procedures (but may not support light-based energy-harvesting procedures). However, the respective devices may not know what types of energy-harvesting sources are supported by other respective devices in the network. In such cases, the respective devices may unsuccessfully attempt to perform energy-harvesting procedures that are not supported by the other respective devices, thereby resulting in increased power consumption and wasted resources.

Accordingly, aspects of the present disclosure are directed to signaling and other mechanisms that enable energy-harvesting and energy-providing devices to exchange capability information (e.g., two-way capability signaling) so that the devices may efficiently perform energy-harvesting procedures that are supported by the other respective devices. For example, an energy-providing device may indicate a set of energy-harvesting procedures/sources it supports, and an energy-harvesting device may indicate which of the set of energy-harvesting procedures/sources it supports (or vice versa). Energy-harvesting procedures may include RF-based energy-harvesting procedures, light-based energy-harvesting procedures, heat-based energy-harvesting procedures, motion-based energy-harvesting procedures, and the like. Subsequently, the energy-providing devices and energy-harvesting devices may be able to perform an energy-harvesting procedure that is supported by both of the respective devices.

In some aspects, energy-harvesting and energy-providing devices may support multiple types of energy procedures/sources, and may be configured to cycle through the supported energy procedures/sources according to some pre-defined cycle or pattern. In such cases, the cycle/pattern of supported energy-harvesting procedures/sources may be indicated or broadcasted to other wireless devices via control/capability signaling. Energy-providing devices may be able to request supported types of energy-harvesting procedures/sources from energy-harvesting devices, and vice versa. Additionally, energy-providing devices may schedule resources (e.g., time/frequency/spatial resources) that will be used for various supported energy-harvesting procedures/sources.

Aspects of the disclosure are initially described in the context of wireless communications systems. Additional aspects of the disclosure are described in the context of an example process flow. Aspects of the disclosure are further illustrated by and described with reference to apparatus diagrams, system diagrams, and flowcharts that relate to techniques for energy transfer devices supporting multiple types of wireless energy transfer.

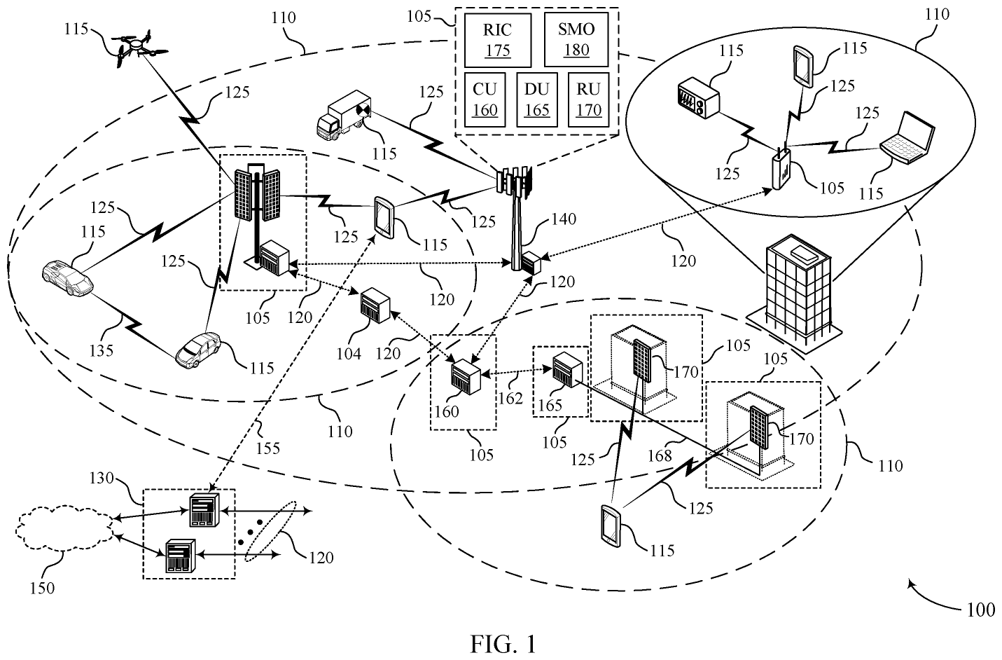

FIG. 1 illustrates an example of a wireless communications system 100 that supports techniques for energy transfer devices supporting multiple types of wireless energy transfer in accordance with one or more aspects of the present disclosure. The wireless communications system 100 includes one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for energy transfer devices supporting multiple types of wireless energy transfer as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving.” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrow band communications), or a combination of these techniques. For example, some UEs 115 may be configured for operation using a narrow band protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some implementations, the wireless communications system 100 may support signaling and other mechanisms that enable energy-harvesting and energy-providing devices to exchange capability information so that the devices may efficiently perform energy-harvesting procedures that are supported by the other respective devices. For example, an energy-providing device of the wireless communications system 100 (e.g., network entity 105, central controller, etc.) may indicate a set of energy-harvesting procedures/sources it supports, and an energy-harvesting device (e.g., UE 115, RFID tag, etc.) may indicate which of the set of energy-harvesting procedures/sources it supports (or vice versa). Energy-harvesting procedures may include RF-based energy-harvesting procedures, light-based energy-harvesting procedures, heat-based energy-harvesting procedures, motion-based energy-harvesting procedures, and the like. Subsequently, the energy-providing devices and energy-harvesting devices may be able to perform an energy-harvesting procedure that is supported by both of the respective devices.

In some aspects, energy-harvesting and energy-providing devices may support multiple types of energy procedures/sources, and may be configured to cycle through the supported energy procedures/sources according to some pre-defined cycle or pattern. In such cases, the cycle/pattern of supported energy-harvesting procedures/sources may be indicated or broadcasted to other wireless devices via capability signaling. Energy-providing devices may be able to request supported types of energy-harvesting procedures/sources from energy-harvesting devices, and vice versa. Additionally, energy-providing devices may schedule resources (e.g., time/frequency/spatial resources) that will be used for various supported energy-harvesting procedures/sources.

Techniques described herein may enable energy-harvesting wireless devices and energy-providing wireless devices to exchange capability information associated with energy-harvesting procedures/sources supported by the respective devices so that the respective devices can efficiently perform energy-harvesting procedures that are supported by both devices (e.g., two-way capability information exchange). In this regard, aspects of the present disclosure may reduce or eliminate the risk that energy-providing devices and/or energy-harvesting devices will inadvertently attempt to perform energy-harvesting procedures that are not supported by the other respective devices, thereby reducing power consumption at the respective devices and reducing control signaling overhead. Moreover, techniques described herein may improve the prevalence of energy-harvesting procedures within the wireless communications system 100, thereby leading to improved battery performance and overall user experience in energy-harvesting devices.

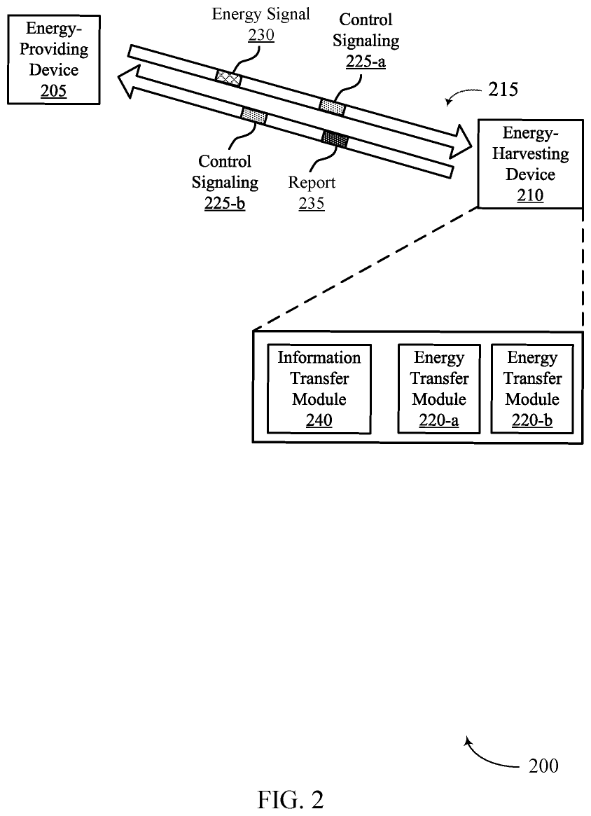

FIG. 2 illustrates an example of a wireless communications system 200 that supports techniques for energy transfer devices supporting multiple types of wireless energy transfer in accordance with one or more aspects of the present disclosure. In some examples, aspects of the wireless communications system 200 may implement, or be implemented by, aspects of the wireless communications system 100. In particular, the wireless communications system 200 may support signaling that enables energy-harvesting wireless devices and energy-providing wireless devices to exchange capability information regarding supported energy-harvesting procedures/sources, as described previously herein.

The wireless communications system 200 includes an energy-providing device 205, and an energy-harvesting device 210. The energy-providing device 205 may include, but is not limited to, a network entity 105, a base station, a UE 115, a central controller (e.g., programmable logic controller (PLC)), and the like. Similarly, the energy-harvesting device 210 may include, but is not limited to, a UE 115, an RFID tag, a passive device, and the like.

In some aspects, the energy-providing device 205 and the energy-harvesting device 210 communicate with one another using a communication link 215, which may be an example of an NR or LTE link between the respective devices. In some cases, the communication link 215 may include an example of an access link (e.g., Uu link) which may include a bi-directional link that enables both uplink and downlink communication. For example, the energy-harvesting device 210 may transmit uplink signals, such as uplink control signals or uplink data signals, to one or more components of the energy-providing device 205 using the communication link 215, and one or more components of the energy-providing device 205 may transmit downlink signals, such as downlink control signals or downlink data signals, to the energy-harvesting device 210 using the communication link 215.

In some implementations, the wireless communications system 200 may include one or more passive devices. In some cases, the energy-harvesting device 210 may be an example of a passive device. Passive devices may include lower-complexity devices (e.g., <100 μW devices) including, but not limited to, RFID tags, passive IoT devices, hybrid devices including passive and active components, passive components of otherwise active/querying devices (e.g., passive components of a UE 115), or any combination thereof.

Passive devices may be implemented in the wireless communications system 200 to support various services and applications, such as identification, tracking, sensing, and the like. Other use cases that may be supported or facilitated by the passive devices may include power sourcing, security applications, access control or access connectivity management, positioning services, and the like. Passive devices may be capable of communicating over different frequency ranges, such as UHF ranges. In some implementations, passive devices such as RFID tags may include relatively low-complexity devices with limited resources and processing power. Moreover, passive devices may include battery-less or limited energy storage (e.g., capacitor) devices capable of wireless communication.

As relatively low-complexity devices with limited (or no) energy storage capabilities, some passive devices (e.g., energy-harvesting device 210) may be configured to perform energy-harvesting procedures in order to generate (and/or store) energy that may be used to perform wireless communications and/or support other capabilities. For example, in some cases, the passive devices may support Energy Harvesting Enabled Communication Services (EHECS) in 5GS.

In some aspects, the energy-harvesting device 210 includes an information transfer module 240 (e.g., module configured to perform wireless communications) and one or more separate energy transfer modules 220-a, 220-b (e.g., energy-harvester modules). The energy-harvesting devices 210 may exhibit different types of receiver architectures for performing energy-harvesting procedures (e.g., periodic energy-harvesting procedures). Possible receiver architectures may include, but are not limited to: (1) a separated receiver architecture, (2) a time-switching receiver architecture, and (3) a power-splitting receiver architecture.

In the context of the separated receiver architecture, the information transfer module 240 may be associated with a separate set of antennas (e.g., Tx/Rx antennas) as compared to the energy transfer modules 220 (e.g., separate sets of antennas used for communications and energy-harvesting procedures). Comparatively, in the context of the time-switching receiver antennas and the power-splitting receiver architecture, the information transfer modules 240 and the energy transfer module(s) 220 may be configured to use the same set of antennas, where signals for wireless communications and energy-harvesting procedures are split in the time domain and the power domain, respectively.

For example, a time-switching architecture may include a time-switching component between a set of antennas and the information transfer module 240/energy transfer modules 220 (e.g., common set of antennas). In this example, the time-switching component is configured to direct signals to/from the antennas and the information transfer module 240/energy transfer modules 220 differently in the time domain (e.g., signals during time interval αT to/from the information transfer module 240, and signals during time interval (1−α) T to/from the energy transfer module(s) 220). Similarly, a power-switching architecture may include a power splitting component between a set of antennas and the information transfer module 240/energy transfer modules 220 (e.g., common set of antennas). In this example, the power-splitting component is configured to direct signals to/from the antennas and the information transfer module 240/energy transfer modules 220 differently in the power domain (e.g., signals with power ρ to/from the information transfer module 240, and signals with power 1−ρ to/from the energy transfer module(s) 220).

As noted previously herein, some wireless communications systems may support multiple types/sources of wireless energy transfer. For example, various devices within the wireless communications system 200 may support RF-based energy-harvesting procedures, light-based energy-harvesting procedures, heat-based energy-harvesting procedures, motion-based energy-harvesting procedures, and the like. For example, in the context of an RF-based energy-harvesting procedure, the energy-providing device 205 may transmit RF signals, where the energy-harvesting device 210 is configured to generate (and/or store) energy based on the received RF signals. Similarly, in the context of a light-based energy-harvesting procedure, the energy-providing device 205 (e.g., Ericsson light power base station) may transmit light signals (e.g., lasers), where the energy-harvesting device 210 is configured to generate (and/or store) energy based on the received light signals.

While energy-harvesting procedures may facilitate communications at energy-harvesting devices, such as passive IoT devices, energy-harvesting procedures may result in increased power consumption at the energy-providing device 205. In particular, there are conflicting interests to facilitate energy transfer/harvesting at energy-harvesting devices 210, while also saving energy or limiting power consumption.

As such, there is a desire to improve an efficiency of energy-harvesting procedures in order to reduce overall power consumption in the network (or limit increased power consumption), while optimizing the performance of energy-harvesting procedures. In some cases, in order to facilitate controlled energy-harvesting procedures, the network (e.g., energy-providing device 205) may switch between power modes according to the network input and the current traffic conditions. For example, in low traffic conditions, the network (e.g., energy-providing device 205, network entity 105) may selectively deactivate some subset of antennas used for wireless communications and/or energy-harvesting procedures in order to reduce power consumption.

Additionally, as described herein, energy-harvesting devices 210 and/or energy-providing devices 205 may support multiple different types/sources of energy-harvesting, including RF-based energy harvesting, light/laser-based energy harvesting, motion-based energy harvesting, heat-based energy harvesting, or any combination thereof. In other words, the energy-harvesting device 210 (e.g., network entity 105, gNB, sidelink device such as a UE 115) may be configured to provide/support more than one type of wireless energy transfer. However, the respective devices may not know what types of energy-harvesting sources are supported by other respective devices in the network. In such cases, the respective devices may unsuccessfully attempt to perform energy-harvesting procedures that are not supported by the other respective devices, thereby resulting in increased power consumption and wasted resources.

Accordingly, aspects of the present disclosure are directed to signaling and other mechanisms that enable the energy-harvesting device 210 and the energy-providing device 205 to exchange capability information (e.g., two-way capability signaling) so that the devices may efficiently perform energy-harvesting procedures that are supported by the other respective devices. For example, an energy-providing device may indicate a set of energy-harvesting procedures/sources it supports, and an energy-harvesting device may indicate which of the set of energy-harvesting procedures/sources it supports (or vice versa). Energy-harvesting procedures may include RF-based energy-harvesting procedures, light-based energy-harvesting procedures, heat-based energy-harvesting procedures, motion-based energy-harvesting procedures, and the like. Subsequently, the energy-providing devices and energy-harvesting devices may be able to perform an energy-harvesting procedure that is supported by both of the respective devices.

For example, referring to the wireless communications system 200, the energy-providing device 205 and the energy-harvesting device 210 exchange control signaling 225-a and control signaling 225-b (e.g., capability signaling), respectively, where the control signaling 225 (e.g., capability signaling) indicates energy-harvesting procedures supported by the respective devices. For the purposes of the present disclosure, the energy-providing device 205 and the energy-harvesting device 210 may be said to “communicate” control signaling 225 which indicates energy-harvesting procedures supported by the respective devices. In such cases, the term “communicating” may be used to refer to transmitting and/or receiving control signaling 225.

For instance, in some cases, the energy-providing device 205 may transmit the control signaling 225-a indicating a set of energy-harvesting procedures supported by the energy-providing device 205, and the energy-harvesting device 210 may transmit the control signaling 225-b indicating which of the set of energy-harvesting procedures are also supported by the energy-harvesting device 210. By way of another example, in some cases, the energy-harvesting device 210 may transmit the control signaling 225-b indicating a set of energy-harvesting procedures supported by the energy-harvesting device 210, and the energy-providing device 205 may transmit the control signaling 225-a indicating which of the set of energy-harvesting procedures are also supported by the energy-providing device 205.

In some aspects, the respective devices may indicate supported energy-harvesting procedures based on pre-defined classes, types, or capabilities. For example, in some cases, the control signaling 225-a may indicate different energy-harvesting types (e.g., defines different classes of energy-harvesting devices), where each respective class supports different energy-harvesting procedures. In this example, the control signaling 225-b may indicate which type/class applies to the energy-harvesting device 210.

For instance, a first class/type of energy-harvesting device (e.g., Energy-Harvesting Class A) may support only a first type (Type 1) of energy-harvesting procedure, where a second class/type of energy-harvesting device (e.g., Energy-Harvesting Class B) may support both the first type (Type 1) of energy-harvesting procedure and a second type (Type 2) of energy-harvesting procedure. By way of another example, a third class/type of energy-harvesting device (e.g., Energy-Harvesting Class C) may support both the first type (Type 1) of energy-harvesting procedure and a third type (Type 3) of energy-harvesting procedure, where a fourth class/type of energy-harvesting device (e.g., Energy-Harvesting Class D) may support only the second type (Type 2) of energy-harvesting procedure. In this example, different bit field values within the respective control signaling 225-a, 225-b may be used to indicate classes/types of supported energy-harvesting procedures.

In some implementations, the energy transfer modules 220-a, 220-b may be associated with different respective energy-harvesting procedures supported by the energy-harvesting device 210. In this regard, the energy transfer modules 220-a, 220-b may include dedicated circuitry, energy storage components, or other components configured to support respective energy-harvesting procedures. For example, the first energy transfer module 220-a may be usable for performing RF-based energy-harvesting procedures, and the second energy transfer module 220-b may be usable for performing light-based energy-harvesting procedures. In some cases, the energy transfer modules 220-a, 220-b may be associated with separate respective energy storage components (e.g., separate batteries), or may share one or more common energy storage components.

In some cases, the respective devices may exchange the control signaling 225 periodically, using wake-up signal (WUS) indications, based on requests received from the other devices, or any combination thereof. For example, the energy-providing device 205 may dynamically or periodically transmit/broadcast control signaling 225-a indicating the energy-harvesting procedures supported by the energy-providing device 205 or other energy-providing devices 205 within the network.

Similarly, the energy-harvesting device 210 may be configured to report (via the control signaling 225-b) which types of wireless energy-harvesting procedures are supported or preferred from time to time. In other words, the energy-harvesting device 210 may report times (e.g., time intervals/durations) between energy transfer associated with the different types of wireless energies (e.g., time intervals between different types of supported energy-harvesting procedures) so that the energy-providing device 205 can adjust the energy transfer for the respective energy-harvesting procedures. Additionally, or alternatively, the energy-harvesting device 210 may indicate or suggest different time intervals/durations during which the devices may perform different energy-harvesting procedures. Communicating such information may enable the respective devices to easily and efficiently switch between different types of energy-harvesting procedures.

For example, the energy-harvesting device 210 may periodically transmit/broadcast control signaling 225-b indicating the energy-harvesting procedures supported by the energy-harvesting device 210. In such cases, the energy-providing device 205 may configure energy resources for different types of energy-harvesting procedures accordingly.

In some cases, the energy-harvesting device 210 may indicate parameters or characteristics associated with supported energy-harvesting procedures, such as energy efficiency metrics, charging rates, energy storage capabilities, and the like. Such indicated parameters/characteristics may enable the energy-providing device 205 to select between the supported energy-harvesting procedures. For example, the energy-providing device 205 may select an energy-harvesting procedure that exhibits the highest energy efficiency to reduce power consumption at the energy-providing device 205. By way of another example, the energy-providing device 205 may select an energy-harvesting procedure that exhibits the highest charging rate in cases where the energy-harvesting device 210 exhibits low power or battery level.

In some aspects, the control signaling 225-a, 225-b transmitted by the respective devices may indicate whether the respective devices are able to perform two or more energy-harvesting procedures at the same time (e.g., simultaneous or temporally-overlapping energy-harvesting procedures). Additionally, or alternatively, in cases where the respective devices support multiple types of energy procedures/sources, the devices may be configured to cycle through the supported energy procedures/sources according to some pre-defined cycle or pattern. In such cases, the cycle/pattern of supported energy-harvesting procedures/sources may be indicated or broadcasted to other wireless devices via the control signaling 225 (e.g., capability signaling).

For example, the energy-harvesting device 210 may support three different energy-harvesting procedures/sources, and may indicate an energy-harvesting pattern (or energy-harvesting cycle) for performing the three respective energy-harvesting procedures. In this example, the energy-harvesting pattern may include a first set of time intervals during which the energy-harvesting device 210 may perform the first type of energy-harvesting procedure, a second set of time intervals during which the energy-harvesting device 210 may perform the second type of energy-harvesting procedure, and a third set of time intervals during which the energy-harvesting device 210 may perform the third type of energy-harvesting procedure. As such, the energy-harvesting device 210 may selectively activate/deactivate circuitry (e.g., energy transfer modules 220-a, 220-b) in order to perform the respective energy-harvesting procedures in accordance with the reported energy-harvesting pattern.

In this regard, the energy-providing device 205 may dedicate energy-harvesting cycles for each respective energy-harvesting procedure in accordance with the reported energy-harvesting pattern, and based on the capabilities of the energy-providing device 205. In other words, if the energy-providing device 205 supports the first and second energy-harvesting procedures, but not the third, the energy-providing device 205 may be configured to perform energy-harvesting procedures during the first and second sets of time intervals of the energy-harvesting pattern, but not during the third set of time intervals (as the energy-providing device 205 does not support the third energy-harvesting procedure that may be performed during the third set of time intervals).

In some cases, the respective devices may report times between energy transfer types so that energy-providing device 205 can adjust the energy transfer for the respective energy-harvesting sources. For example, the energy-harvesting device 210 may report (via control signaling 225-b) “switching times” that it takes the energy-harvesting device 210 to switch from one type of energy-harvesting procedure to another. In other words, the energy-harvesting device 210 (and/or energy-providing device 205) may report “switching times” indicating time durations that it takes to power down the first energy transfer module 220-a associated with a first energy-harvesting procedure, and power-up the second energy transfer module 220-b associated with a second energy-harvesting procedure. By reporting switching times, the respective devices may further streamline the ability to perform energy-harvesting procedures in an efficient and effective manner. The control signaling 225-a, 225-b transmitted by the respective devices may include other information associated with energy-harvesting procedures supported by the respective devices, such as quasi co-location (QCL) indicators, transmission-configuration indicator (TCI) states, transmission-reception points (TRPS), and the like. For example, in some cases, the energy-providing device 205 may include multiple TRPs for light sources configured to transmit light-based energy signals 230, and the control signaling 225-a may indicate QCL indications for the respective TRPs so that the respective devices (e.g., energy-providing device 205, energy-harvesting device 210) may perform light-combining for a light-based energy-harvesting procedure. For instance, the control signaling 225-a may indicate a first QCL indicator associated with a first TRP at the energy-providing device 205, and a second QCL indicator associated with a second TRP at the energy-providing device 205. In this example, the devices may be configured to perform subsequent energy-harvesting procedures in accordance with the QCL indications and corresponding TRPs.

After exchanging the control signaling 225-a, 225-b indicating the respective energy-harvesting procedures supported by the respective devices, the energy-providing device 205, the energy-harvesting device 210, or both, may be configured to select one or more energy-harvesting procedures supported by both devices. In some cases, the device(s) may select one or more supported energy-harvesting procedures based on the parameters/characteristics associated with the respective procedures (e.g., charging rate, energy efficiency, energy storage capabilities, etc.).

In some aspects, the energy-providing device 205 may be configured to allocate resources (e.g., time, frequency, spatial resources) for performing the one or more supported energy-harvesting procedures. The resource allocation for performing the one or more supported energy-harvesting procedures may be indicated via the control signaling 225-a, additional control signaling (e.g., RRC, DCI, MAC-CE), or both. In some aspects, the energy-providing device 205 may indicate a selected energy-harvesting procedure that is to be performed in a WUS to the energy-harvesting device 210. In some cases, the WUS (or other control signaling) may indicate a type of energy-harvesting procedure that is to be performed, applicable data circuits/energy-harvesting circuits (e.g., which energy transfer module(s) 220 the energy-harvesting device 210 is expected to wake up or activate), an energy-harvesting configuration for the energy-harvesting procedure (e.g., periodicity/resources for energy signals 230, filtering coefficient(s) in the energy signal 230 domain), and the like. Energy-harvesting configurations may be communicated between the respective devices (e.g., using the information transfer module 240) via Layer 1 (L1) signaling, Layer 2 (L2) signaling, Layer 3 (L3) signaling, or any combination thereof.

For example, a WUS or other signaling may indicate an energy-harvesting configuration indicating resources for applicable energy signals 230, RF filters for RF-based energy signals 230, power domain filters for light-based (e.g., laser-based) harvesting procedures, and the like. By way of another example, the energy-providing device 205 may transmit a WUS indicating for the energy-harvesting device 210 to activate or wake-up the information transfer module 240, to activate/wake-up the first energy-transfer module 220-a with a first energy-harvesting configuration, and to activate/wake-up the second energy transfer module 220-b with a second energy-harvesting configuration.

Subsequently, the energy-providing device 205 and the energy-harvesting device 210 may perform one or more energy-harvesting procedures supported by both the respective devices. In particular, the energy-harvesting device 210 receives an energy signal 230 (e.g., RF signal, light signal, heat signal) in accordance with an indicated energy-harvesting configuration. For example, the energy-harvesting device 210 may receive the energy signal(s) 230 within a set of resources allocated by the energy-providing device 205, and indicated via the energy-harvesting configuration. Moreover, the respective devices may perform the energy-harvesting procedure in accordance with a reported energy-harvesting pattern/cycle. In cases where the energy-harvesting device 210 and the energy-providing device 205 are able to perform temporally overlapping (e.g., simultaneous) energy-harvesting procedures, the energy-providing device 205 may be configured to transmit multiple types of energy signals 230 associated with multiple types of supported energy-harvesting procedures. In such cases, the multiple energy signals 230 may at least partially overlap in the time domain.

The energy-harvesting device 210 may be configured to generate energy based on the received energy signal(s) 230. The generated energy may be used to perform wireless communications, or to perform other operations/applications supported by the energy-harvesting device 210 (e.g., smart metering, inventory monitoring, water level monitoring, equipment monitoring, healthcare monitoring, wildlife monitoring, weather and geological event monitoring, fleet management and tracking, remote security sensing, physical access control, transaction-based business charging, etc.). Moreover, in cases where the energy-harvesting device 210 (e.g., energy transfer modules 220) include energy storage components, such as batteries or capacitors, the energy-harvesting device 210 may be configured to store the generated energy within the respective energy storage components. Energy storage components may include, but are not limited to, batteries (e.g., rechargeable batteries), supercapacitors, and the like.

In some aspects, the energy-harvesting device 210 transmits a report 235 to the energy-providing device 205, where the report indicates parameters/characteristics associated with the energy-harvesting procedures. The parameters/characteristics associated with the energy-harvesting procedure that may be indicated via the report may include, but are not limited to, a charging rate, an energy efficiency, an energy storage capacity, and the like. For example, after receiving the energy signal 230 associated with the energy-harvesting procedure, the energy-harvesting device may transmit a report 235 that indicates the charging rate and/or energy efficiency of the energy-harvesting procedure.

In some cases, the energy-harvesting device 210 may be configured to transmit the report 235 based on the charging rate for the respective energy-harvesting procedure satisfying (e.g., exceeding) some configurable threshold. In such cases, charging rate thresholds may be configured/signaled for each respective energy resource or energy-harvesting procedure/source. Additionally, or alternatively, the energy-harvesting device 210 may be configured to send a charging rate report for other energy-harvesting procedures that are not supported by the network (e.g., energy-harvesting procedures/sources that are not provided by the energy-providing device 205). In such cases, the network (e.g., energy-providing device 205) may be configured to use such charging rate information to determine how much extra/additional energy is needed by the device.

In some aspects, a charging rate threshold against which the energy-harvesting device 210 compares charging rates may be the same for all energy-harvesting procedures/technologies, or different for each respective energy-harvesting procedure/technology (e.g., energy-harvesting procedures based on vibration, thermal, laser/solar, RF from other devices or bands, other RF technologies such as WiFi, LTE, Bluetooth, etc.). Moreover, charging rate thresholds may be configured based on whether or not the charging rates are supported by the network. For example, the energy-providing device 205 may configure a first charging rate threshold for all energy-harvesting procedures that are supported by the network, a second charging rate threshold for all energy-harvesting procedures that are not supported/provided by the network, a third charging rate threshold across all accumulated energy-harvesting procedures regardless of energy source, or any combination thereof. Such charging rate threshold(s) may, in some cases, represent the power/energy needed to perform certain functions or operations, such as to decode data, encode data, receive, filter, perform RF (re) tuning processes to transmit/receive data, receive one or more of PDSCH/PSSCH/reference signals, transmit one or more of PUSCH/PSSCH/reference signals with certain number of time/frequency resources (or resource elements), or any combination thereof.

In some aspects, the report 235 may enable the energy-providing device 205 and/or the energy-harvesting device 210 to select a new energy-harvesting procedure, and/or adjust Tx/Rx parameters to improve the efficiency of the energy-harvesting procedure. In this regard, the energy-providing device 205 and the energy-harvesting device 210 may be configured to selectively adjust Tx parameters and Rx parameters, respectively associated with energy-harvesting procedures based on the reports 235. In the context of light-based energy-harvesting procedures, the energy-providing device 205 may be configured to train light collecting cells (e.g., solar cells) at the energy-harvesting device 210 on different beam combining weights or directions using reference signals transmitted by light and configured resources using the data module (e.g., information transfer module 240). Stated differently, the energy-providing device 205 may transmit energy signals 230 using different combinations of beam combining weights (e.g., different weights of energy signals 230 transmitted via different TRPs), where the reports 235 are used to determine which beam combining weights (and/or other parameters) exhibit the best performance. Similarly, in the context of RF-based energy-harvesting procedures, the energy-providing device 205 may transmit energy signals 230 using different combinations of spatial filters, TCI states, QCL indicators, TRPs, etc., where the reports 235 are used to determine which sets of parameters/characteristics of RF-based energy signals 230 exhibit the best (or sufficient) performance.

In some cases, the energy-harvesting device 210 may transmit the report(s) 235 based on (e.g., in accordance with) a reporting configuration for transmitting reports associated with energy-harvesting procedures performed at the energy-harvesting device 210. The reporting configuration may be indicated via the control signaling 225-b and/or additional control signaling, and may indicate sets of resources usable for transmitting energy-harvesting reports, a reporting frequency (e.g., periodicity for transmitting energy-harvesting reports), a type of reporting (e.g., periodic reporting, aperiodic reporting, semi-persistent reporting, etc.), and the like.

In cases where the energy-harvesting device 210 supports multiple different energy-harvesting procedures, the reporting configuration may indicate or include dedicated resources for transmitting reports associated with the respective energy-harvesting procedures, or a common set of resources usable for transmitting reports for both types of energy-harvesting procedures. For example, the reporting configuration may indicate a set of resources that are usable by the energy-harvesting device 210 to multiplex energy transfer reports associated with the respective energy-harvesting procedures supported by the energy-harvesting device 210. By way of another example, the reporting configuration may cause the energy-harvesting device 210 to transmit reports 235 indicating the charging rate report from each type of wireless energy-harvesting procedure, where the reports 235 for the respective energy-harvesting procedures may be bundled, transmitted via orthogonal resources, and the like.

In some implementations, the uplink resources (e.g., PUCCH resources) used to transmit the reports 235 (e.g., charging rate reports 235) may be configured by the network, such as a network entity 105 and/or the energy-providing device 205, such as via PUCCH resources, PUSCH resources MAC-CE, RRC signaling, user assistance information, and the like. In some cases, different sets of resources may be configured for transmitting reports 235 associated with different energy-harvesting procedures. In such cases, the sets of resources may be associated with orthogonal resources. Additionally, or alternatively, a common set of resources may be used to transmit reports 235 for multiple energy-harvesting procedures. In some aspects, reports 235 (e.g., charging rate reports) may be communicated on dedicated PUCCH and/or PUSCH resources, piggy backed with other types of messages (e.g., scheduling request messages, buffer status report (BSR) messages, RACH messages), piggy backed with HARQ-ACK feedback from the energy-harvesting device 210, or any combination thereof.

In cases where both the energy-providing device 205 and the energy-harvesting device 210 include UEs 115, the reports 235 may be communicated via PUSCH/PUCCH resources if the UEs 115 communicate through Uu link using uplink PHY channels, or via PSSCH or PSFCH resources (e.g., sidelink control information (SCI)) if the UEs 115 communicate via a sidelink such as PC5-RRC or a PHY interface.

In some cases, the energy-harvesting device 210, the energy-providing device 205, or both, may indicate time intervals during which the respective devices may not support a previously-supported energy-harvesting procedure. In other words, the energy-harvesting device 210 and/or the energy-providing device 205 may transmit a cease/stop/suspension signal which indicates that the respective device no longer supports an indicated energy-harvesting procedure for some indicated (or pre-defined) time interval/duration. Such indications may be communicated via control signaling 225, capability signaling, a report 235, or any combination thereof.

For example, the energy-providing device 205 (e.g., network entity 105, gNB) may broadcast a signal to all energy-harvesting device 210 within the network that the energy-providing device 205 will cease/stop sending energy signals 230 of certain type (e.g., associated with a certain type of energy-harvesting procedure) for a certain time duration. In some cases, the cease/stop indication may be broadcast/transmitted using some type of wireless charging technology. In some cases, the energy-harvesting device 210 may cease/stop performance of some type of energy-harvesting procedure to reduce power consumption/perform power saving in cases where all (or most) energy-harvesting devices 210 in the network are performing a certain type of energy-harvesting. In other words, the network/energy-providing device 205 may turn off one or more supported energy-harvesting procedures based on a quantity of energy-providing devices 205 that are performing the respective energy-harvesting procedure failing to satisfy a threshold quantity of devices (e.g., if there are only two devices performing light-based energy harvesting, the energy-providing device 205 may stop performance of light-based energy-harvesting procedures to reduce power consumption).

Techniques described herein may enable the energy-harvesting device 210 and the energy-providing device 205 to exchange capability information associated with energy-harvesting procedures/sources supported by the respective devices so that the respective devices can efficiently perform energy-harvesting procedures that are supported by both devices (e.g., two-way capability information exchange). In this regard, aspects of the present disclosure may reduce or eliminate the risk that the energy-providing device 205 and the energy-harvesting device 210 will inadvertently attempt to perform energy-harvesting procedures that are not supported by the other respective devices, thereby reducing power consumption at the respective devices and reducing control signaling overhead. Moreover, techniques described herein may improve the prevalence of energy-harvesting procedures within the wireless communications system 200, thereby leading to improved battery performance and overall user experience in the energy-harvesting device 210.

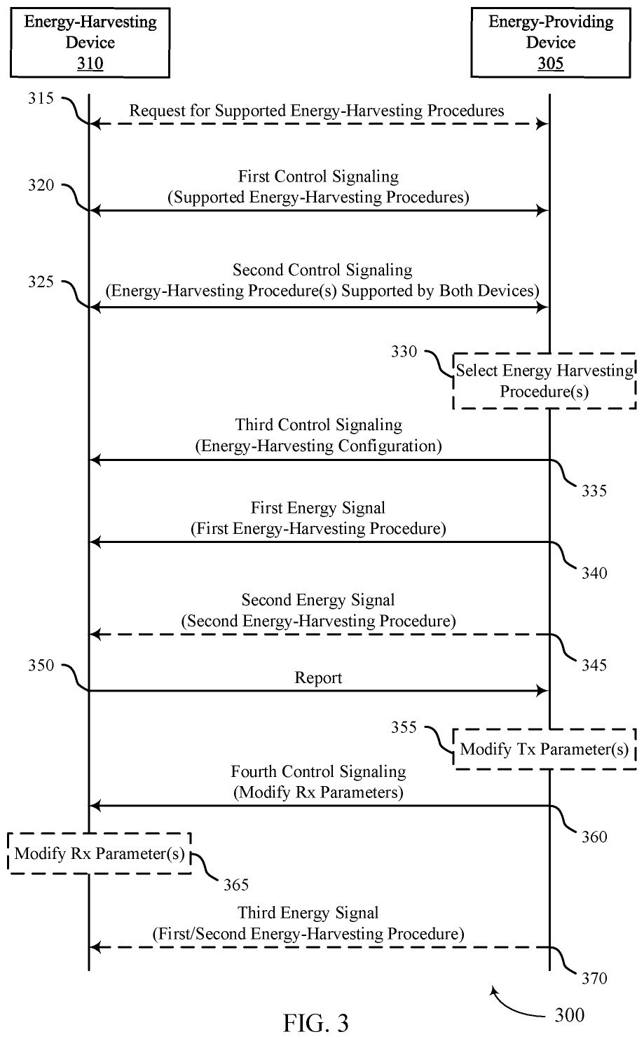

FIG. 3 illustrates an example of a process flow 300 that supports techniques for energy transfer devices supporting multiple types of wireless energy transfer in accordance with one or more aspects of the present disclosure. In some examples, aspects of the process flow 300 may implement, or be implemented by, aspects of the wireless communications system 100, the wireless communications system 200, or both. In particular, the process flow 300 illustrates two-way capability signaling between wireless devices associated with energy-harvesting procedures supported by the respective devices, as described with reference to FIGS. 1-6, among other aspects.

The process flow 300 includes an energy-providing device 305 and an energy-harvesting device 310, which may be examples of energy-providing devices, energy-harvesting devices, passive devices, UEs 115, network entities 105, and other wireless devices described with reference to FIGS. 1-2. For example, the energy-providing device 305 and the energy-harvesting device 310 illustrated in FIG. 3 may be examples of the energy-providing device 205 and the energy-harvesting device 210, respectively, as shown and described in FIG. 2. In this regard, the energy-providing device 305 may include, but is not limited to, a network entity 105, a base station, a UE 115, a central controller (e.g., PLC), and the like. Similarly, the energy-harvesting device 310 may include, but is not limited to, a UE 115, an RFID tag, a passive device, and the like.

In some examples, the operations illustrated in process flow 300 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

At 315, the respective devices communicate (e.g., transmit or receive) a request for energy-harvesting procedures supported by the other respective device. For example, the energy-harvesting device 310 may transmit a request for energy-harvesting procedures supported by the energy-providing device 305. Conversely, in other cases, the energy-providing device 305 may transmit a request for energy-harvesting procedures supported by the energy-harvesting device 310.

At 320, the respective devices communicate first control signaling (e.g., first capability signaling) indicating a set of energy-harvesting procedures supported by one of the energy-harvesting device 310 or the energy-providing device 305. Similarly, at 325, the respective devices may communicate second control signaling (e.g., second capability signaling) indicating at least one energy-harvesting procedure (e.g., a first energy-harvesting procedure) that is supported by both of the respective devices.

The energy-harvesting procedures supported by the respective devices may include, but are not limited to, RF-based energy-harvesting procedures, a light-based energy-harvesting procedures, a motion-based energy-harvesting procedures, a heat-based energy-harvesting procedures, or any combination thereof. In some aspects, the respective devices may communicate the first control signaling and/or the second control signaling based on transmitting/receiving the request at 315.

For example, in some cases, the energy-providing device 305 may transmit the first control signaling at 320 indicating a set of energy-harvesting procedures supported by the energy-providing device 305, and the energy-harvesting device 310 may transmit the second control signaling at 325 indicating which of the set of energy-harvesting procedures are also supported by the energy-harvesting device 310. By way of another example, in other cases, the energy-harvesting device 310 may transmit the first control signaling at 320 indicating a set of energy-harvesting procedures supported by the energy-harvesting device 310, and the energy-providing device 305 may transmit the second control signaling at 325 indicating which of the set of energy-harvesting procedures are also supported by the energy-providing device 305.

The first control signaling at 320, the second control signaling at 325, additional control signaling (e.g., L1, L2, L3 control signaling), or any combination thereof, may include capability indications which indicate whether the respective devices are able to perform multiple temporally-overlapping (e.g., simultaneous) energy-harvesting procedures. Moreover, the first control signaling at 320, the second control signaling at 325, additional control signaling (e.g., L1, L2, L3 control signaling), or any combination thereof, may indicate various parameters or characteristics associated with supported energy-harvesting procedures. Other parameters/characteristics associated with supported energy-harvesting procedures may include, but are not limited to, energy-harvesting patterns/cycles, energy efficiency metrics, charging rates, energy storage capacities/capabilities, TRPs, QCL indicators, TCI states, a reporting configuration, or any combination thereof.

At 330, the energy-providing device 305 may select one or more energy-harvesting procedures that are supported by both of the respective devices. The energy-providing device 305 may select the one or more energy-harvesting procedures at 330 based on communicating (e.g., transmitting or receiving) the request at 315, communicating the first control signaling at 320, communicating the second control signaling at 325, or any combination thereof. For example, the energy-providing device 305 may select an energy-harvesting procedure that is associated with a highest charging rate or energy efficiency at one (or both) of the respective devices.

At 335, the energy-harvesting device 310 may receive third control signaling (e.g., RRC, DCI, MAC-CE, WUS) from the energy-providing device 305. The third control signaling may indicate the energy-harvesting procedure(s) to be performed between the respective devices, and corresponding energy-harvesting configuration(s) associated with the respective procedures.

In some aspects, the energy-harvesting configuration(s) may indicate various parameters or characteristics associated with the energy-harvesting procedures that are to be performed between the respective devices, including allocated resources (e.g., time, frequency, spatial resources) usable for performing the energy-harvesting procedures, energy-harvesting patterns/cycles for performing the energy-harvesting procedures, and the like. By way of another example, the energy-harvesting configurations may indicate QCL indicators, TCI states, TRPs, spatial filters, beam combining weights, and the like, for performing the energy-harvesting procedures.

In additional or alternative implementations, the first control signaling at 320, the second control signaling at 325, the third control signaling at 335, or any combination thereof, may indicate a reporting configuration for transmitting reports associated with the supported energy-harvesting procedure(s). The reporting configuration may include resources for transmitting energy-harvesting reports, a periodicity for transmitting energy-harvesting reports, a type of energy-harvesting reports (e.g., periodic, aperiodic, semi-persistent), and the like.

At 340, the energy-harvesting device 310 may receive, from the energy-providing device 305, a first energy signal associated with the first energy-harvesting procedure supported by both the respective devices. As noted previously herein, the energy signal may include an RF-based energy signal, a light-based energy signal, a heat-based energy signal, and the like.

The devices may communicate (e.g., transmit, receive) the first energy signal at 340 based on communicating the request at 315, communicating the first control signaling at 320, communicating the second control signaling at 325, selecting the first energy-harvesting procedure at 330, communicating the third control signaling at 335, or any combination thereof. For example, the energy-harvesting device 310 may receive (and the energy-providing device 305 may transmit) the first energy signal in accordance with an indicated energy-harvesting pattern/cycle (e.g., within a time interval of the pattern/cycle that is associated with the first energy-harvesting procedure). Additionally, or alternatively, the energy-harvesting device 310 may receive the first energy signal within the set of resources allocated via the third control signaling.

By way of another example, the energy-harvesting device 310 may receive the first energy signal with additional or alternative parameters associated with the first energy-harvesting procedure and/or indicated via the first, second, and/or third control signaling, such as indicated TCI states, QCL indications, TRPs, and the like.

At 345, the energy-harvesting device 310 may receive, from the energy-providing device 305, a second energy signal associated with a second energy-harvesting procedure supported by both the respective devices. As noted previously herein, the energy signal may include an RF-based energy signal, a light-based energy signal, a heat-based energy signal, and the like.

In some implementations, the second energy signal may temporally overlap with the first energy signal. In other words, the energy-harvesting device 310 and the energy-providing device 305 may perform temporally-overlapping energy-harvesting procedures. In such cases, the energy-providing device 305 may transmit the temporally-overlapping energy signals based on a capability indication from the energy-harvesting device 310 indicating that the energy-harvesting device 310 is able to perform temporally-overlapping energy-harvesting procedures.

The energy-harvesting device 310 may receive the second energy signal based on parameters associated with the second energy-harvesting procedure and/or indicated via the first, second, and/or third control signaling. As such, any description associated with transmission/reception of the first energy signal at 340 may be regarded as applying to transmission/reception of the second energy signal at 345.

At 350, the energy-harvesting device 310 may transmit a report to the energy-providing device 305, where the report indicates parameters/characteristics associated with the first energy-harvesting procedure, the second energy-harvesting procedure, or both. Parameters/characteristics associated with the respective energy-harvesting procedures indicated via the report may include, but are not limited to, charging rates, energy efficiency metrics, energy storage capacity/capability metrics, and the like. Additionally, or alternatively, the report may indicate a request for the energy-providing device 305 to modify one or more parameters/characteristics associated with one or more energy-harvesting procedures. In this regard, the energy-harvesting device 310 may transmit the report based on receiving the first energy signal at 340, receiving the second energy signal at 345, or both.

Moreover, the energy-harvesting device 310 may transmit the report at 350 in accordance with the reporting configuration indicated via any of the first, second, and/or third control signaling. For example, the energy-harvesting device 310 may transmit the report at 350 within a set of resources indicated via the reporting configuration.

At 355, the energy-providing device 305 may selectively modify one or more Tx parameters associated with the first energy-harvesting procedure, the second energy-harvesting procedure, or both. In particular, the energy-providing device 305 may modify the one or more Tx parameters at 355 based on the report received at 350 (e.g., based on a request and/or information included within the report). In additional or alternative implementations, the energy-providing device 305 may selectively modify the one or more Tx parameters autonomously (e.g., not based on the report at 350). Tx parameters that may be modified may include, but are not limited to, Tx powers, beam combining weights, spatial filters, and the like.

At 360, the energy-harvesting device 310 may receive, from the energy-providing device 305, fourth control signaling indicating for the energy-harvesting device 310 to selectively modify one or more Rx parameters associated with the first energy-harvesting procedure, the second energy-harvesting procedure, or both. In particular, the energy-harvesting device 310 may receive the fourth control signaling at 360 based on transmitting the report at 350. Rx parameters that may be modified may include, but are not limited to, beam combining weights, spatial filters, and the like.

At 365, the energy-harvesting device 310 may selectively modify one or more Rx parameters associated with the first energy-harvesting procedure, the second energy-harvesting procedure, or both. In this regard, the energy-harvesting device 310 may modify the one or more Rx parameters at 365 based on transmitting the report at 350, receiving the fourth control signaling at 360, or both.

At 370, the energy-harvesting device 310 may receive, from the energy-providing device 305, a third energy signal associated with the first energy-harvesting procedure, the second energy-harvesting procedure, or both. For example, in some cases, the energy-harvesting device 310 may receive energy signals associated with both the first energy-harvesting procedure and the second energy-harvesting procedure, where parameters for the energy signals have been modified at 365. In particular, the energy-harvesting device 310 may receive (and the energy-providing device 305 may transmit) the third energy signal at 370 based on transmitting/receiving the report at 350, modifying the Tx parameters at 355, receiving/transmitting the fourth control signaling at 360, modifying the Rx parameters at 365, or any combination thereof.

The energy-harvesting device 310 may receive the third energy signal based on parameters associated with the first/second energy-harvesting procedure and/or indicated via the first, second, and/or third control signaling. As such, any description associated with transmission/reception of the first and second energy signals at 340 and 345, respectively, may be regarded as applying to transmission/reception of the third energy signal at 370.

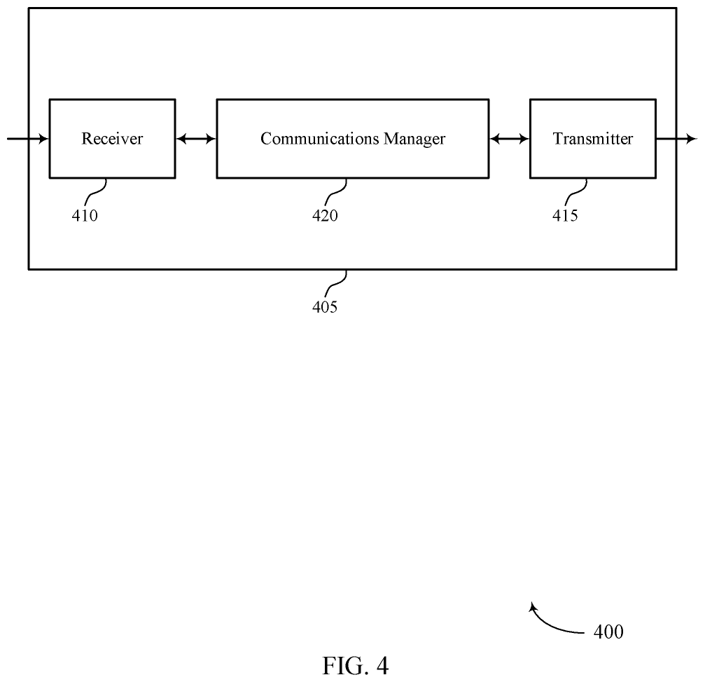

FIG. 4 shows a diagram 400 of a device 405 that supports techniques for energy transfer devices supporting multiple types of wireless energy transfer in accordance with one or more aspects of the present disclosure. The device 405 may be an example of aspects of a UE 115 or other energy-harvesting device as described herein. The device 405 includes a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for energy transfer devices supporting multiple types of wireless energy transfer). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for energy transfer devices supporting multiple types of wireless energy transfer). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of techniques for energy transfer devices supporting multiple types of wireless energy transfer as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication at an energy-harvesting wireless device in accordance with examples as disclosed herein. For example, the communications manager 420 may be configured as or otherwise support a means for communicating, with an energy-providing wireless device, first control signaling indicating a set of multiple energy-harvesting procedures supported by the energy-providing wireless device or the energy-harvesting wireless device. The communications manager 420 may be configured as or otherwise support a means for communicating, with the energy-providing wireless device based on the first control signaling, second control signaling indicating at least one energy-harvesting procedure supported by the energy-providing wireless device and the energy-harvesting wireless device, the at least one energy-harvesting procedure included within the set of multiple energy-harvesting procedures. The communications manager 420 may be configured as or otherwise support a means for receiving, from the energy-providing wireless device, an energy signal associated with the at least one energy-harvesting procedure.

By including or configuring the communications manager 420 in accordance with examples as described herein, the device 405 (e.g., a processor controlling or otherwise coupled with the receiver 410, the transmitter 415, the communications manager 420, or a combination thereof) may support techniques that enable energy-harvesting wireless devices and energy-providing wireless devices to exchange capability information associated with energy-harvesting procedures/sources supported by the respective devices so that the respective devices can efficiently perform energy-harvesting procedures that are supported by both devices (e.g., two-way capability information exchange). In this regard, aspects of the present disclosure may reduce or eliminate the risk that energy-providing devices and/or energy-harvesting devices will inadvertently attempt to perform energy-harvesting procedures that are not supported by the other respective devices, thereby reducing power consumption at the respective devices and reducing control signaling overhead. Moreover, techniques described herein may improve the prevalence of energy-harvesting procedures within the wireless communications system 100, thereby leading to improved battery performance and overall user experience in energy-harvesting devices.

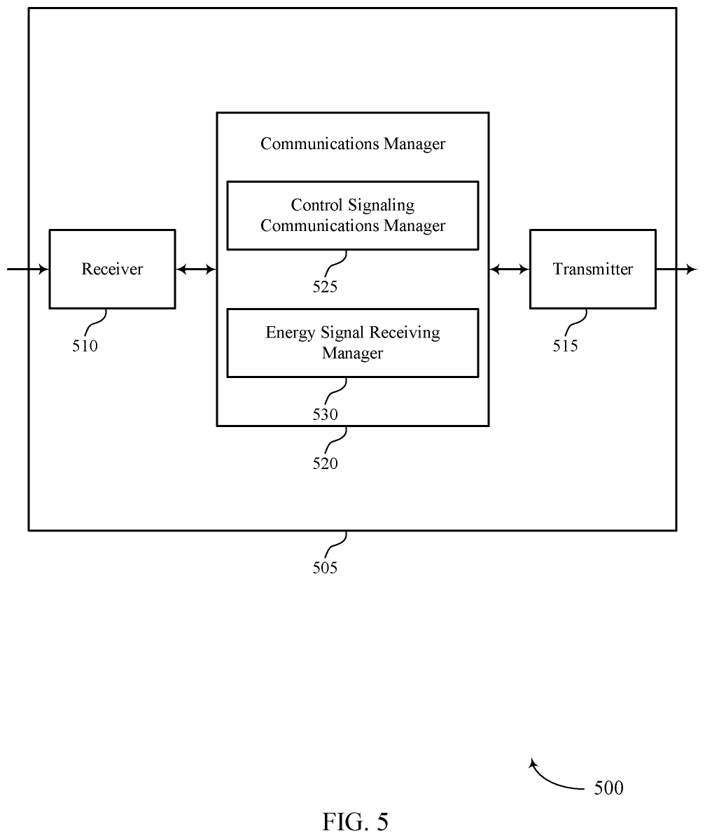

FIG. 5 shows a diagram 500 of a device 505 that supports techniques for energy transfer devices supporting multiple types of wireless energy transfer in accordance with one or more aspects of the present disclosure. The device 505 may be an example of aspects of a device 405, a UE 115, or another energy-harvesting device, as described herein. The device 505 includes a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for energy transfer devices supporting multiple types of wireless energy transfer). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for energy transfer devices supporting multiple types of wireless energy transfer). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques for energy transfer devices supporting multiple types of wireless energy transfer as described herein. In the embodiment of FIG. 5, the communications manager 520 includes a control signaling communications manager 525 and an energy signal receiving manager 530. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at an energy-harvesting wireless device in accordance with examples as disclosed herein. The control signaling communications manager 525 may be configured as or otherwise support a means for communicating, with an energy-providing wireless device, first control signaling indicating a set of multiple energy-harvesting procedures supported by the energy-providing wireless device or the energy-harvesting wireless device. The control signaling communications manager 525 may be configured as or otherwise support a means for communicating, with the energy-providing wireless device based on the first control signaling, second control signaling indicating at least one energy-harvesting procedure supported by the energy-providing wireless device and the energy-harvesting wireless device, the at least one energy-harvesting procedure included within the set of multiple energy-harvesting procedures. The energy signal receiving manager 530 may be configured as or otherwise support a means for receiving, from the energy-providing wireless device, an energy signal associated with the at least one energy-harvesting procedure.

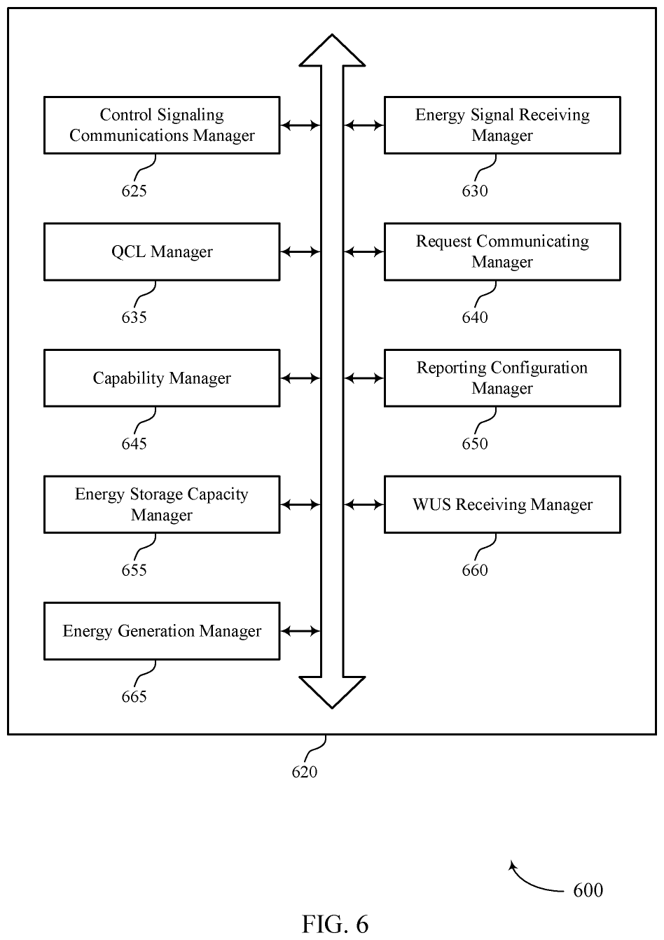

FIG. 6 shows a diagram 600 of a communications manager 620 that supports techniques for energy transfer devices (e.g., energy-harvesting device) supporting multiple types of wireless energy transfer in accordance with one or more aspects of the present disclosure. The communications manager 620 may be an example of aspects of a communications manager 420, a communications manager 520, or both, as described herein. The communications manager 620, or various components thereof, may be an example of means for performing various aspects of techniques for energy transfer devices supporting multiple types of wireless energy transfer as described herein. In the embodiment of FIG. 6, the communications manager 620 includes a control signaling communications manager 625, an energy signal receiving manager 630, a QCL manager 635, a request communicating manager 640, a capability manager 645, a reporting configuration manager 650, an energy storage capacity manager 655, a WUS receiving manager 660, and an energy generation manager 665. In other embodiments, the communications manager may include any combination thereof. Each of these components may communicate, directly or indirectly, with one another (e.g., via one or more buses).

The communications manager 620 may support wireless communication at an energy-harvesting wireless device in accordance with examples as disclosed herein. The control signaling communications manager 625 may be configured as or otherwise support a means for communicating, with an energy-providing wireless device, first control signaling indicating a set of multiple energy-harvesting procedures supported by the energy-providing wireless device or the energy-harvesting wireless device. In some examples, the control signaling communications manager 625 may be configured as or otherwise support a means for communicating, with the energy-providing wireless device based on the first control signaling, second control signaling indicating at least one energy-harvesting procedure supported by the energy-providing wireless device and the energy-harvesting wireless device, the at least one energy-harvesting procedure included within the set of multiple energy-harvesting procedures. The energy signal receiving manager 630 may be configured as or otherwise support a means for receiving, from the energy-providing wireless device, an energy signal associated with the at least one energy-harvesting procedure.

In some examples, the control signaling communications manager 625 may be configured as or otherwise support a means for communicating, with the energy-providing wireless device, the first control signaling indicating an energy-harvesting pattern associated with the energy-providing wireless device or the energy-harvesting wireless device, where the energy signal is received within a time interval of a set of multiple time intervals of the energy-harvesting pattern.

In some examples, the control signaling communications manager 625 may be configured as or otherwise support a means for transmitting, to the energy-providing wireless device, the first control signaling indicating one or more parameters associated with at least one of the set of multiple energy-harvesting procedures supported by the energy-harvesting wireless device, the one or more parameters indicating an energy efficiency, a charging rate, or both, where the second control signaling is received based on the one or more parameters.

In some examples, the control signaling communications manager 625 may be configured as or otherwise support a means for receiving, from the energy-providing wireless device, the second control signaling or additional control signaling indicating a set of resources usable for performing the at least one energy-harvesting procedure, where the energy signal is received within the set of resources.

In some examples, the control signaling communications manager 625 may be configured as or otherwise support a means for receiving, from the energy-providing wireless device, the second control signaling or additional control signaling indicating a QCL indicator, a TCI state, a TRP associated with the energy-providing wireless device, or any combination thereof, where receiving the energy signal is based on the QCL indicator, the TCI state, the TRP, or any combination thereof.

In some examples, the QCL manager 635 may be configured as or otherwise support a means for receiving a first QCL indicator and a second QCL indicator associated with a first TRP and a second TRP, respectively, associated with the energy-providing wireless device. In some examples, the energy signal receiving manager 630 may be configured as or otherwise support a means for receiving the energy signal associated with the at least one energy-harvesting procedure via the first TRP and in accordance with the first QCL indicator. In some examples, the energy signal receiving manager 630 may be configured as or otherwise support a means for receiving an additional energy signal associated with the at least one energy-harvesting procedure via the second TRP and in accordance with the second QCL indicator.

In some examples, the request communicating manager 640 may be configured as or otherwise support a means for communicating, with the energy-providing wireless device, a request for the set of multiple energy-harvesting procedures supported by the energy-providing wireless device or the energy-harvesting wireless device, where communicating the first control signaling, the second control signaling, or both, is based on the request.

In some examples, the energy signal is received during a first time interval, and the capability manager 645 may be configured as or otherwise support a means for communicating, with the energy-providing wireless device, a capability indication that the energy-harvesting wireless device is capable of performing multiple temporally-overlapping energy-harvesting procedures. In some examples, the energy signal is received during a first time interval, and the energy signal receiving manager 630 may be configured as or otherwise support a means for receiving, from the energy-providing wireless device, a second energy signal associated with an additional energy-harvesting procedure based on the capability indication, where the second energy signal is received during a second time interval that at least partially overlaps in a time domain with the first time interval.

In some examples, the reporting configuration manager 650 may be configured as or otherwise support a means for transmitting, to the energy-providing wireless device based on receiving the energy signal, a report indicating one or more parameters associated with the at least one energy-harvesting procedure.

In some examples, the reporting configuration manager 650 may be configured as or otherwise support a means for receiving, from the energy-providing wireless device, a reporting configuration for transmitting reports associated with energy-harvesting procedures, where the report is transmitted in accordance with the reporting configuration.

In some examples, the energy signal receiving manager 630 may be configured as or otherwise support a means for receiving, from the energy-providing wireless device based on transmitting the report, an instruction to selectively adjust one or more reception parameters for receiving energy signals associated with the at least one energy-harvesting procedure. In some examples, the energy signal receiving manager 630 may be configured as or otherwise support a means for receiving an additional energy signal associated with the at least one energy-harvesting procedure based on the instruction.

In some examples, the control signaling communications manager 625 may be configured as or otherwise support a means for receiving additional control signaling indicating a set of multiple energy-harvesting types, where each energy-harvesting type supports a respective set of energy-harvesting procedures. In some examples, the control signaling communications manager 625 may be configured as or otherwise support a means for communicating, via the first control signaling, an indication of an energy-harvesting type associated with the energy-harvesting wireless device, where communicating the second control signaling, receiving the energy signal, or both, is based on the energy-harvesting type.

In some examples, the control signaling communications manager 625 may be configured as or otherwise support a means for communicating, with the energy-providing wireless device, third control signaling indicating that one or more energy-harvesting procedures of the set of multiple energy-harvesting procedures is no longer supported by the energy-providing wireless device or the energy-harvesting wireless device for a time interval.

In some examples, the control signaling communications manager 625 may be configured as or otherwise support a means for transmitting, to the energy-providing wireless device, the first control signaling indicating the set of multiple energy-harvesting procedures supported by the energy-harvesting wireless device. In some examples, the control signaling communications manager 625 may be configured as or otherwise support a means for receiving, from the energy-providing wireless device, the second control signaling indicating the at least one energy-harvesting procedure supported by the energy-providing wireless device.

In some examples, the control signaling communications manager 625 may be configured as or otherwise support a means for receiving, from the energy-providing wireless device, the first control signaling indicating the set of multiple energy-harvesting procedures supported by the energy-providing wireless device. In some examples, the control signaling communications manager 625 may be configured as or otherwise support a means for transmitting, to the energy-providing wireless device, the second control signaling indicating the at least one energy-harvesting procedure supported by the energy-harvesting wireless device.

In some examples, the set of multiple energy-harvesting procedures include a first energy-harvesting procedure and a second energy-harvesting procedure, and the energy storage capacity manager 655 may be configured as or otherwise support a means for transmitting, to the energy-harvesting wireless device via the first control signaling or the second control signaling, a first energy storage capacity associated with the first energy-harvesting procedure, a second energy storage capacity associated with the second energy-harvesting procedure, a third energy storage capacity associated with both the first energy-harvesting procedure and the second energy-harvesting procedure, or any combination thereof, where receiving the energy signal is based on the first energy storage capacity, the second energy storage capacity, the third energy storage capacity, or any combination thereof.

In some examples, the WUS receiving manager 660 may be configured as or otherwise support a means for receiving a WUS from the energy-providing wireless device, where receiving the energy signal is based on receiving the WUS.

In some examples, the energy generation manager 665 may be configured as or otherwise support a means for generating energy based on receiving the energy signal. In some examples, the energy generation manager 665 may be configured as or otherwise support a means for performing one or more communications or other operations using the generated energy, storing the generated energy in an energy storage component, or both.

In some examples, the set of multiple energy-harvesting procedures includes an RF-based energy-harvesting procedure, a light-based energy-harvesting procedure, a motion-based energy-harvesting procedure, a heat-based energy-harvesting procedure, or any combination thereof. In some examples, the energy-harvesting wireless device includes a UE. In some examples, the energy-providing wireless device includes a network entity.

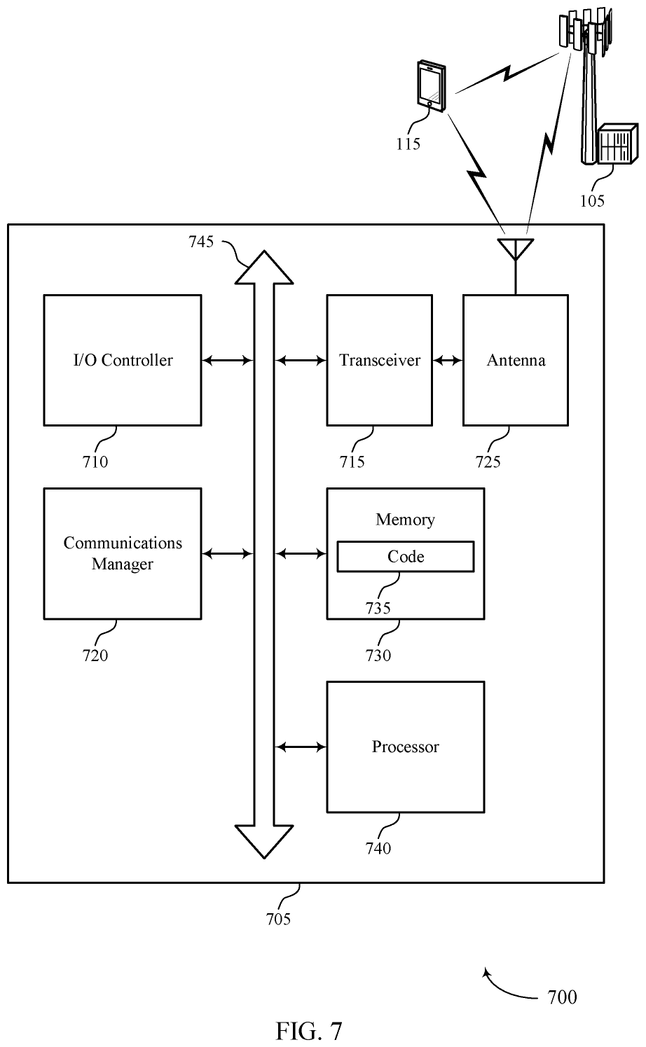

FIG. 7 shows a diagram of a system 700 including a device 705 that supports techniques for energy transfer devices supporting multiple types of wireless energy transfer in accordance with one or more aspects of the present disclosure. The device 705 may be an example of or include the components of a device 405, a device 505, a UE 115, or other energy-providing device, as described herein. The device 705 may communicate (e.g., wirelessly) with one or more network entities 105, one or more UEs 115, or any combination thereof. The device 705 may include components for bi-directional voice and data communications including components for transmitting and receiving communications. In the embodiment of FIG. 7, the device 705 includes a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting techniques for energy transfer devices supporting multiple types of wireless energy transfer). For example, the device 705 or a component of the device 705 may include a processor 740 and memory 730 coupled with or to the processor 740, the processor 740 and memory 730 configured to perform various functions described herein.

The communications manager 720 may support wireless communication at an energy-harvesting wireless device in accordance with examples as disclosed herein. For example, the communications manager 720 may be configured as or otherwise support a means for communicating, with an energy-providing wireless device, first control signaling indicating a set of multiple energy-harvesting procedures supported by the energy-providing wireless device or the energy-harvesting wireless device. The communications manager 720 may be configured as or otherwise support a means for communicating, with the energy-providing wireless device based on the first control signaling, second control signaling indicating at least one energy-harvesting procedure supported by the energy-providing wireless device and the energy-harvesting wireless device, the at least one energy-harvesting procedure included within the set of multiple energy-harvesting procedures. The communications manager 720 may be configured as or otherwise support a means for receiving, from the energy-providing wireless device, an energy signal associated with the at least one energy-harvesting procedure.

By including or configuring the communications manager 720 in accordance with examples as described herein, the device 705 may support techniques that enable energy-harvesting wireless devices and energy-providing wireless devices to exchange capability information associated with energy-harvesting procedures/sources supported by the respective devices so that the respective devices can efficiently perform energy-harvesting procedures that are supported by both devices (e.g., two-way capability information exchange). In this regard, aspects of the present disclosure may reduce or eliminate the risk that energy-providing devices and/or energy-harvesting devices will inadvertently attempt to perform energy-harvesting procedures that are not supported by the other respective devices, thereby reducing power consumption at the respective devices and reducing control signaling overhead. Moreover, techniques described herein may improve the prevalence of energy-harvesting procedures within the wireless communications system 100, thereby leading to improved battery performance and overall user experience in energy-harvesting devices.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of techniques for energy transfer devices supporting multiple types of wireless energy transfer as described herein, or the processor 740 and the memory 730 may be otherwise configured to perform or support such operations.

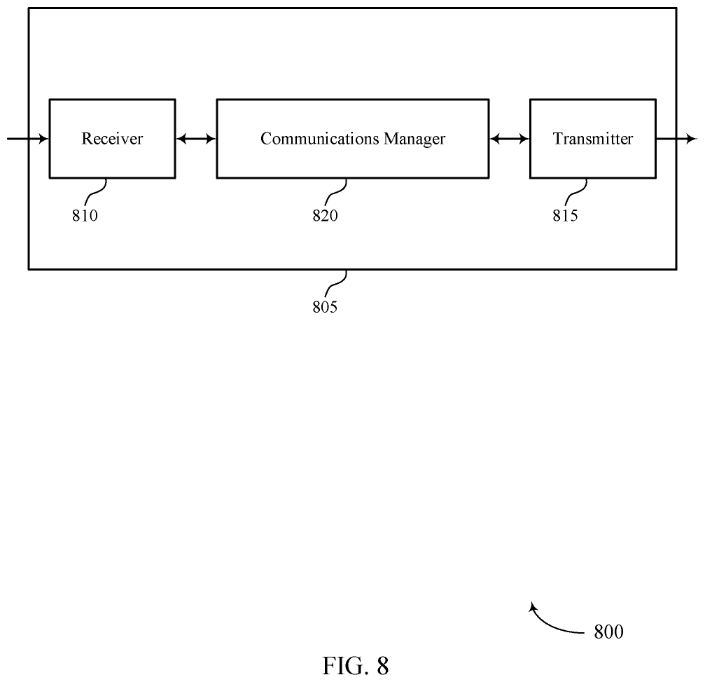

FIG. 8 shows a diagram 800 of a device 805 that supports techniques for energy transfer devices supporting multiple types of wireless energy transfer in accordance with one or more aspects of the present disclosure. The device 805 may be an example of aspects of a network entity 105 or other energy-providing device as described herein. The device 805 includes a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of techniques for energy transfer devices supporting multiple types of wireless energy transfer as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at an energy-providing wireless device in accordance with examples as disclosed herein. For example, the communications manager 820 may be configured as or otherwise support a means for communicating, with an energy-harvesting wireless device, first control signaling indicating a set of multiple energy-harvesting procedures supported by the energy-providing wireless device or the energy-harvesting wireless device. The communications manager 820 may be configured as or otherwise support a means for communicating, with the energy-harvesting wireless device based on the first control signaling, second control signaling indicating at least one energy-harvesting procedure supported by the energy-providing wireless device and the energy-harvesting wireless device, the at least one energy-harvesting procedure included within the set of multiple energy-harvesting procedures. The communications manager 820 may be configured as or otherwise support a means for transmitting, to the energy-harvesting wireless device, an energy signal associated with the at least one energy-harvesting procedure.

By including or configuring the communications manager 820 in accordance with examples as described herein, the device 805 (e.g., a processor controlling or otherwise coupled with the receiver 810, the transmitter 815, the communications manager 820, or a combination thereof) may support techniques that enable energy-harvesting wireless devices and energy-providing wireless devices to exchange capability information associated with energy-harvesting procedures/sources supported by the respective devices so that the respective devices can efficiently perform energy-harvesting procedures that are supported by both devices (e.g., two-way capability information exchange). In this regard, aspects of the present disclosure may reduce or eliminate the risk that energy-providing devices and/or energy-harvesting devices will inadvertently attempt to perform energy-harvesting procedures that are not supported by the other respective devices, thereby reducing power consumption at the respective devices and reducing control signaling overhead. Moreover, techniques described herein may improve the prevalence of energy-harvesting procedures within the wireless communications system 100, thereby leading to improved battery performance and overall user experience in energy-harvesting devices.

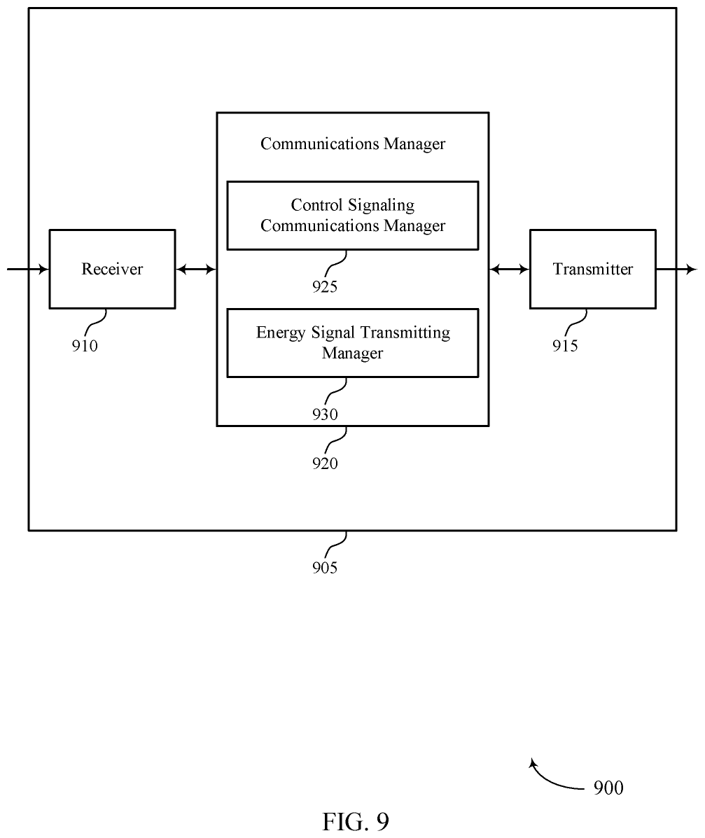

FIG. 9 shows a diagram 900 of a device 905 that supports techniques for energy transfer devices supporting multiple types of wireless energy transfer in accordance with one or more aspects of the present disclosure. The device 905 may be an example of aspects of a device 805, a network entity 105, or other energy-providing device, as described herein. The device 905 includes a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of techniques for energy transfer devices supporting multiple types of wireless energy transfer as described herein. In the embodiment of FIG. 9, the communications manager 920 includes a control signaling communications manager 925 and an energy signal transmitting manager 930. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at an energy-providing wireless device in accordance with examples as disclosed herein. The control signaling communications manager 925 may be configured as or otherwise support a means for communicating, with an energy-harvesting wireless device, first control signaling indicating a set of multiple energy-harvesting procedures supported by the energy-providing wireless device or the energy-harvesting wireless device. The control signaling communications manager 925 may be configured as or otherwise support a means for communicating, with the energy-harvesting wireless device based on the first control signaling, second control signaling indicating at least one energy-harvesting procedure supported by the energy-providing wireless device and the energy-harvesting wireless device, the at least one energy-harvesting procedure included within the set of multiple energy-harvesting procedures. The energy signal transmitting manager 930 may be configured as or otherwise support a means for transmitting, to the energy-harvesting wireless device, an energy signal associated with the at least one energy-harvesting procedure.

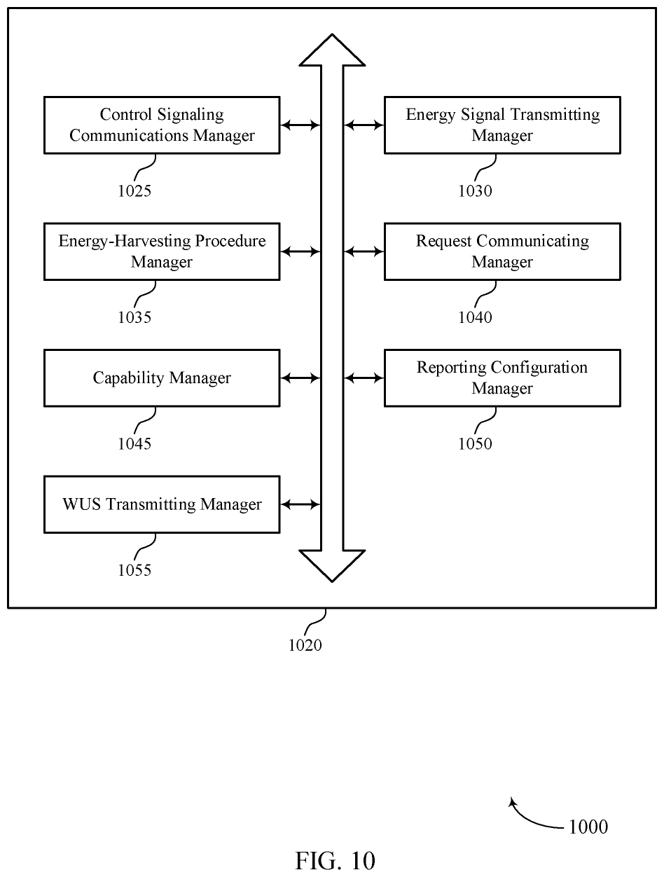

FIG. 10 shows a diagram 1000 of a communications manager 1020 that supports techniques for energy transfer devices (e.g., energy-providing device) supporting multiple types of wireless energy transfer in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for energy transfer devices supporting multiple types of wireless energy transfer as described herein. In the embodiment of FIG. 10, the communications manager 1020 includes a control signaling communications manager 1025, an energy signal transmitting manager 1030, an energy-harvesting procedure manager 1035, a request communicating manager 1040, a capability manager 1045, a reporting configuration manager 1050, a WUS transmitting manager 1055. In other embodiments, the communications manager may include any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communication at an energy-providing wireless device in accordance with examples as disclosed herein. The control signaling communications manager 1025 may be configured as or otherwise support a means for communicating, with an energy-harvesting wireless device, first control signaling indicating a set of multiple energy-harvesting procedures supported by the energy-providing wireless device or the energy-harvesting wireless device. In some examples, the control signaling communications manager 1025 may be configured as or otherwise support a means for communicating, with the energy-harvesting wireless device based on the first control signaling, second control signaling indicating at least one energy-harvesting procedure supported by the energy-providing wireless device and the energy-harvesting wireless device, the at least one energy-harvesting procedure included within the set of multiple energy-harvesting procedures. The energy signal transmitting manager 1030 may be configured as or otherwise support a means for transmitting, to the energy-harvesting wireless device, an energy signal associated with the at least one energy-harvesting procedure.

In some examples, the control signaling communications manager 1025 may be configured as or otherwise support a means for communicating, with the energy-harvesting wireless device, the first control signaling indicating an energy-harvesting pattern associated with the energy-providing wireless device or the energy-harvesting wireless device, where the energy signal is transmitted within a time interval of a set of multiple time intervals of the energy-harvesting pattern.

In some examples, the control signaling communications manager 1025 may be configured as or otherwise support a means for receiving, from the energy-harvesting wireless device, the first control signaling indicating one or more parameters associated with at least one of the set of multiple energy-harvesting procedures supported by the energy-harvesting wireless device, the one or more parameters indicating an energy efficiency, a charging rate, or both. In some examples, the energy-harvesting procedure manager 1035 may be configured as or otherwise support a means for selecting the at least one energy-harvesting procedure from the set of multiple energy-harvesting procedures based on the one or more parameters, where the second control signaling is transmitted based on the selecting.

In some examples, the control signaling communications manager 1025 may be configured as or otherwise support a means for transmitting, to the energy-harvesting wireless device, the second control signaling or additional control signaling indicating a set of resources usable for performing the at least one energy-harvesting procedure, where the energy signal is transmitted within the set of resources.

In some examples, the control signaling communications manager 1025 may be configured as or otherwise support a means for transmitting, to the energy-harvesting wireless device, the second control signaling or additional control signaling indicating a QCL indicator, a TCI state, a TRP associated with the energy-providing wireless device, or any combination thereof, where transmitting the energy signal is based on the QCL indicator, the TCI state, the TRP, or any combination thereof.

In some examples, the request communicating manager 1040 may be configured as or otherwise support a means for communicating, with the energy-harvesting wireless device, a request for the set of multiple energy-harvesting procedures supported by the energy-providing wireless device or the energy-harvesting wireless device, where communicating the first control signaling, the second control signaling, or both, is based on the request.

In some examples, the energy signal is transmitted during a first time interval, and the capability manager 1045 may be configured as or otherwise support a means for communicating, with the energy-harvesting wireless device, a capability indication that the energy-harvesting wireless device is capable of performing multiple temporally-overlapping energy-harvesting procedures. In some examples, the energy signal is transmitted during a first time interval, and the energy signal transmitting manager 1030 may be configured as or otherwise support a means for transmitting, to the energy-harvesting wireless device, a second energy signal associated with an additional energy-harvesting procedure based on the capability indication, where the second energy signal is transmitted during a second time interval that at least partially overlaps in a time domain with the first time interval.

In some examples, the reporting configuration manager 1050 may be configured as or otherwise support a means for receiving, from the energy-harvesting wireless device based on transmitting the energy signal, a report indicating one or more parameters associated with the at least one energy-harvesting procedure.

In some examples, the reporting configuration manager 1050 may be configured as or otherwise support a means for transmitting, to the energy-harvesting wireless device, a reporting configuration for transmitting reports associated with energy-harvesting procedures, where the report is received in accordance with the reporting configuration.

In some examples, the energy-harvesting procedure manager 1035 may be configured as or otherwise support a means for transmitting, to the energy-harvesting wireless device based on receiving the report, an instruction to selectively adjust one or more reception parameters for receiving energy signals associated with the at least one energy-harvesting procedure. In some examples, the energy signal transmitting manager 1030 may be configured as or otherwise support a means for transmitting an additional energy signal associated with the at least one energy-harvesting procedure based on the instruction.

In some examples, the energy-harvesting procedure manager 1035 may be configured as or otherwise support a means for selectively adjusting one or more transmission parameters for transmitting energy signals based on the report. In some examples, the energy signal transmitting manager 1030 may be configured as or otherwise support a means for transmitting an additional energy signal associated with the at least one energy-harvesting procedure based on selectively adjusting the one or more transmission parameters.

In some examples, the control signaling communications manager 1025 may be configured as or otherwise support a means for communicating, with the energy-harvesting wireless device, third control signaling indicating that one or more energy-harvesting procedures of the set of multiple energy-harvesting procedures is no longer supported by the energy-providing wireless device or the energy-harvesting wireless device for a time interval.

In some examples, the WUS transmitting manager 1055 may be configured as or otherwise support a means for transmitting a WUS to the energy-harvesting wireless device, where transmitting the energy signal is based on transmitting the WUS.

In some examples, the set of multiple energy-harvesting procedures includes an RF-based energy-harvesting procedure, a light-based energy-harvesting procedure, a motion-based energy-harvesting procedure, a heat-based energy-harvesting procedure, or any combination thereof. In some examples, the energy-harvesting wireless device includes a UE. In some examples, the energy-providing wireless device includes a network entity.

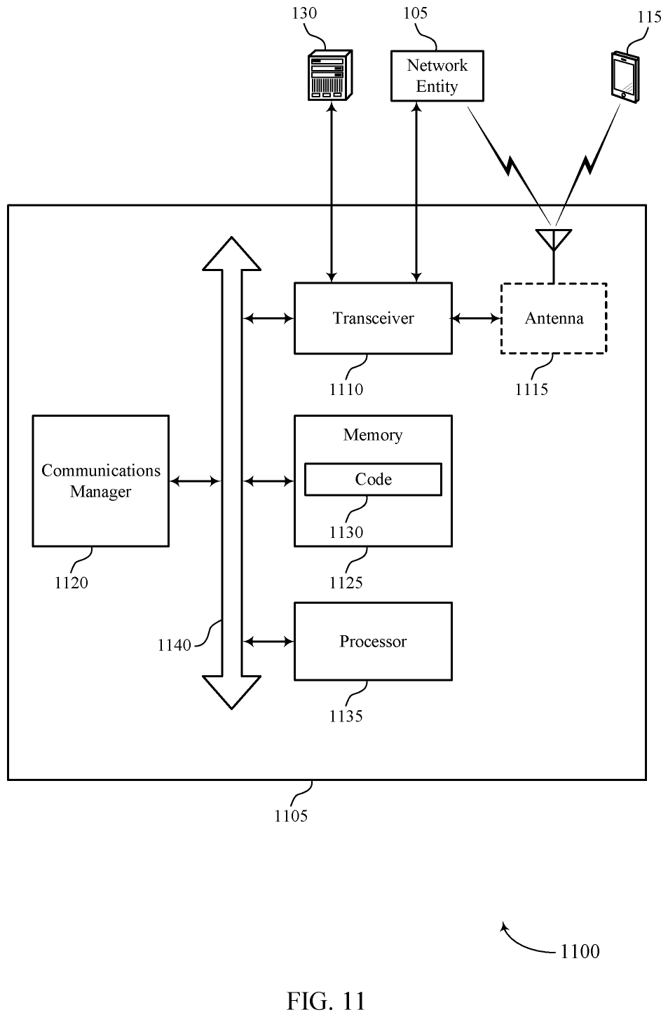

FIG. 11 shows a diagram of a system 1100 including a device 1105 that supports techniques for energy transfer devices supporting multiple types of wireless energy transfer in accordance with one or more aspects of the present disclosure. The device 1105 may be an example of or include the components of a device 805, a device 905, a network entity 105, or other energy-providing device, as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications. In the embodiment of FIG. 11, the device 1105 includes a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or memory components (for example, the processor 1135, or the memory 1125, or both), may be included in a chip or chip assembly that is installed in the device 1105. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting techniques for energy transfer devices supporting multiple types of wireless energy transfer). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105. The processor 1135 may be any one or more suitable processors capable of executing scripts or instructions of one or more software programs stored in the device 1105 (such as within the memory 1125). In some implementations, the processor 1135 may be a component of a processing system. A processing system may generally refer to a system or series of machines or components that receives inputs and processes the inputs to produce a set of outputs (which may be passed to other systems or components of, for example, the device 1105). For example, a processing system of the device 1105 may refer to a system including the various other components or subcomponents of the device 1105, such as the processor 1135, or the transceiver 1110, or the communications manager 1120, or other components or combinations of components of the device 1105. The processing system of the device 1105 may interface with other components of the device 1105, and may process information received from other components (such as inputs or signals) or output information to other components. For example, a chip or modem of the device 1105 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1105 may transmit information output from the chip or modem. Additionally, or alternatively, in some implementations, the one or more interfaces may refer to an interface between the processing system of the chip or modem and a receiver, such that the device 1105 may obtain information or signal inputs, and the information may be passed to the processing system. A person having ordinary skill in the art will readily recognize that a first interface also may obtain information or signal inputs, and a second interface also may output information or signal outputs.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communication at an energy-providing wireless device in accordance with examples as disclosed herein. For example, the communications manager 1120 may be configured as or otherwise support a means for communicating, with an energy-harvesting wireless device, first control signaling indicating a set of multiple energy-harvesting procedures supported by the energy-providing wireless device or the energy-harvesting wireless device. The communications manager 1120 may be configured as or otherwise support a means for communicating, with the energy-harvesting wireless device based on the first control signaling, second control signaling indicating at least one energy-harvesting procedure supported by the energy-providing wireless device and the energy-harvesting wireless device, the at least one energy-harvesting procedure included within the set of multiple energy-harvesting procedures. The communications manager 1120 may be configured as or otherwise support a means for transmitting, to the energy-harvesting wireless device, an energy signal associated with the at least one energy-harvesting procedure.

By including or configuring the communications manager 1120 in accordance with examples as described herein, the device 1105 may support techniques that enable energy-harvesting wireless devices and energy-providing wireless devices to exchange capability information associated with energy-harvesting procedures/sources supported by the respective devices so that the respective devices can efficiently perform energy-harvesting procedures that are supported by both devices (e.g., two-way capability information exchange). In this regard, aspects of the present disclosure may reduce or eliminate the risk that energy-providing devices and/or energy-harvesting devices will inadvertently attempt to perform energy-harvesting procedures that are not supported by the other respective devices, thereby reducing power consumption at the respective devices and reducing control signaling overhead. Moreover, techniques described herein may improve the prevalence of energy-harvesting procedures within the wireless communications system 100, thereby leading to improved battery performance and overall user experience in energy-harvesting devices.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, the processor 1135, the memory 1125, the code 1130, or any combination thereof. For example, the code 1130 may include instructions executable by the processor 1135 to cause the device 1105 to perform various aspects of techniques for energy transfer devices supporting multiple types of wireless energy transfer as described herein, or the processor 1135 and the memory 1125 may be otherwise configured to perform or support such operations.

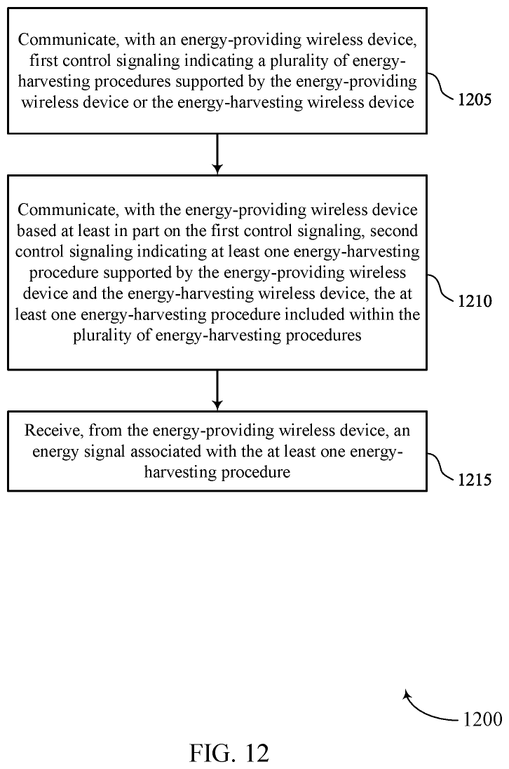

FIG. 12 shows a flowchart illustrating a method 1200 that supports techniques for energy transfer devices supporting multiple types of wireless energy transfer in accordance with one or more aspects of the present disclosure. The operations of the method 1200 may be implemented by an energy-harvesting device, such as a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method includes communicating, with an energy-providing wireless device, first control signaling indicating a set of multiple energy-harvesting procedures supported by the energy-providing wireless device or the energy-harvesting wireless device. The operations of 1205 may be performed in accordance with examples as disclosed herein. In some examples, aspects of the operations of 1205 may be performed by a control signaling communications manager 525 as described with reference to FIG. 5 and/or a control signaling communications manager 625 as described with reference to FIG. 6.

At 1210, the method includes communicating, with the energy-providing wireless device based on the first control signaling, second control signaling indicating at least one energy-harvesting procedure supported by the energy-providing wireless device and the energy-harvesting wireless device, the at least one energy-harvesting procedure included within the set of multiple energy-harvesting procedures. The operations of 1210 may be performed in accordance with examples as disclosed herein. In some examples, aspects of the operations of 1210 may be performed by a control signaling communications manager 625 as described with reference to FIG. 6.

At 1215, the method includes receiving, from the energy-providing wireless device, an energy signal associated with the at least one energy-harvesting procedure. The operations of 1215 may be performed in accordance with examples as disclosed herein. In some examples, aspects of the operations of 1215 may be performed by a control signaling communications manager 525 as described with reference to FIG. 5 and/or an energy signal receiving manager 630 as described with reference to FIG. 6.

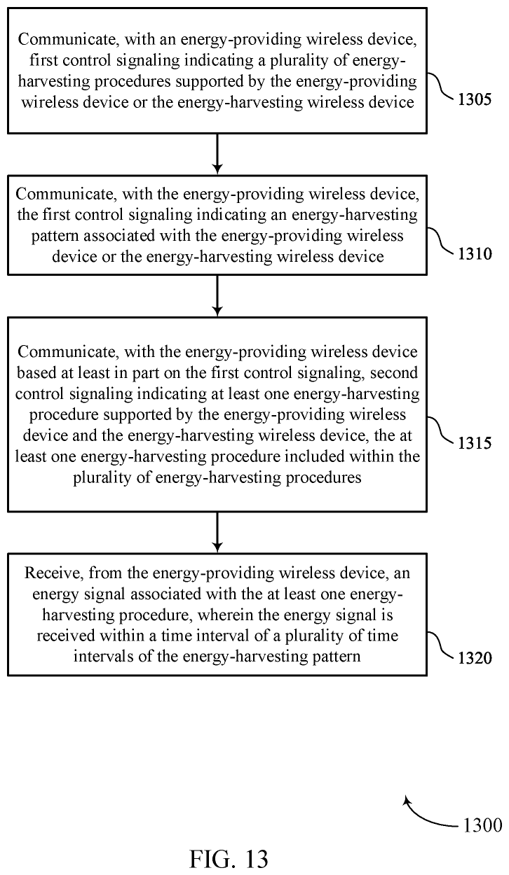

FIG. 13 shows a flowchart illustrating a method 1300 that supports techniques for energy transfer devices supporting multiple types of wireless energy transfer in accordance with one or more aspects of the present disclosure. The operations of the method 1300 may be implemented by an energy-harvesting device, such as a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method includes communicating (e.g., transmitting, receiving), with an energy-providing wireless device, first control signaling indicating a set of multiple energy-harvesting procedures supported by the energy-providing wireless device or the energy-harvesting wireless device. The operations of 1305 may be performed in accordance with examples as disclosed herein. In some examples, aspects of the operations of 305 may be performed by a control signaling communications manager 525 as described with reference to FIG. 5 and/or a control signaling communications manager 625 as described with reference to FIG. 6.

At 1310, the method includes communicating (e.g., transmitting, receiving), with an energy-providing wireless device, first control signaling indicating an energy-harvesting pattern associated with the energy-providing wireless device or the energy-harvesting wireless device. The operations of 1310 may be performed in accordance with examples as disclosed herein. In some examples, aspects of the operations of 1310 may be performed by a control signaling communications manager 525 as described with reference to FIG. 5 and/or a control signaling communications manager 625 as described with reference to FIG. 6.

At 1315, the method includes communicating (e.g., transmitting, receiving), with the energy-providing wireless device based on the first control signaling, second control signaling indicating at least one energy-harvesting procedure supported by the energy-providing wireless device and the energy-harvesting wireless device, the at least one energy-harvesting procedure included within the set of multiple energy-harvesting procedures. The operations of 1315 may be performed in accordance with examples as disclosed herein. In some examples, aspects of the operations of 1315 may be performed by a control signaling communications manager 625 as described with reference to FIG. 6.

At 1320, the method includes receiving, from the energy-providing wireless device, an energy signal associated with the at least one energy-harvesting procedure, wherein the energy signal is received within a time interval of a plurality of time intervals of the energy-harvesting pattern. The operations of 1320 may be performed in accordance with examples as disclosed herein. In some examples, aspects of the operations of 1320 may be performed by an energy signal receiving manager 530 as described with reference to FIG. 5 and/or an energy signal receiving manager 630 as described with reference to FIG. 6.

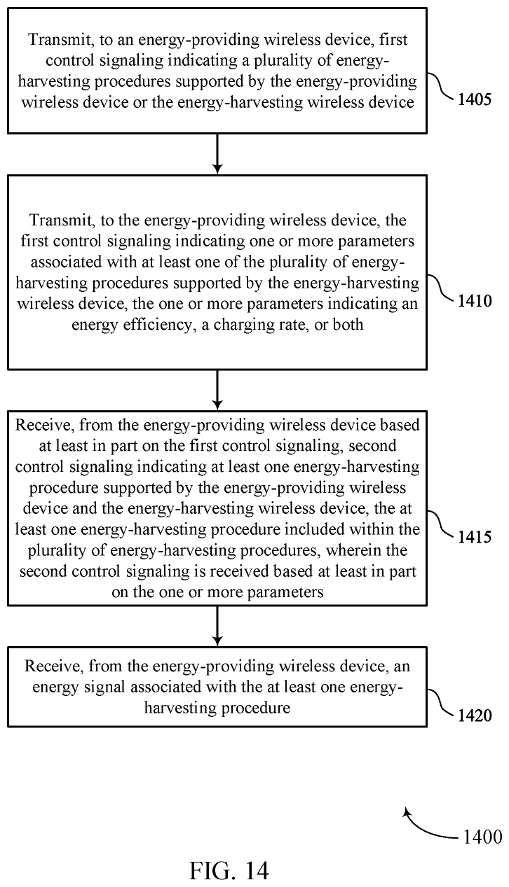

FIG. 14 shows a flowchart illustrating a method 1400 that supports techniques for energy transfer devices supporting multiple types of wireless energy transfer in accordance with one or more aspects of the present disclosure. The operations of the method 1400 may be implemented by an energy-harvesting device, such as a UE or its components as described herein. For example, the operations of the method 1400 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1405, the method includes transmitting, to an energy-providing wireless device, first control signaling indicating a set of multiple energy-harvesting procedures supported by the energy-providing wireless device or the energy-harvesting wireless device. The operations of 1405 may be performed in accordance with examples as disclosed herein. In some examples, aspects of the operations of 1405 may be performed by a control signaling communications manager 525 as described with reference to FIG. 5 and/or a control signaling communications manager 625 as described with reference to FIG. 6.

At 1410, the method includes transmitting, to the energy-providing wireless device, the first control signaling indicating one or more parameters associated with at least one of the set of multiple energy-harvesting procedures supported by the energy-harvesting wireless device, the one or more parameters indicating an energy efficiency, a charging rate, or both. The operations of 1410 may be performed in accordance with examples as disclosed herein. In some examples, aspects of the operations of 1410 may be performed by a control signaling communications manager 525 as described with reference to FIG. 5 and/or a control signaling communications manager 625 as described with reference to FIG. 6.

At 1415, the method includes receiving, from the energy-providing wireless device based on the first control signaling, second control signaling indicating at least one energy-harvesting procedure supported by the energy-providing wireless device and the energy-harvesting wireless device, the at least one energy-harvesting procedure included within the set of multiple energy-harvesting procedures, where the second control signaling is received based on the one or more parameters. The operations of 1415 may be performed in accordance with examples as disclosed herein. In some examples, aspects of the operations of 1415 may be performed by a control signaling communications manager 525 as described with reference to FIG. 5 and/or a control signaling communications manager 625 as described with reference to FIG. 6.

At 1420, the method may include receiving, from the energy-providing wireless device, an energy signal associated with the at least one energy-harvesting procedure. The operations of 1420 may be performed in accordance with examples as disclosed herein. In some examples, aspects of the operations of 1420 may be performed by an energy signal receiving manager 530 as described with reference to FIG. 5 and/or an energy signal receiving manager 630 as described with reference to FIG. 6.

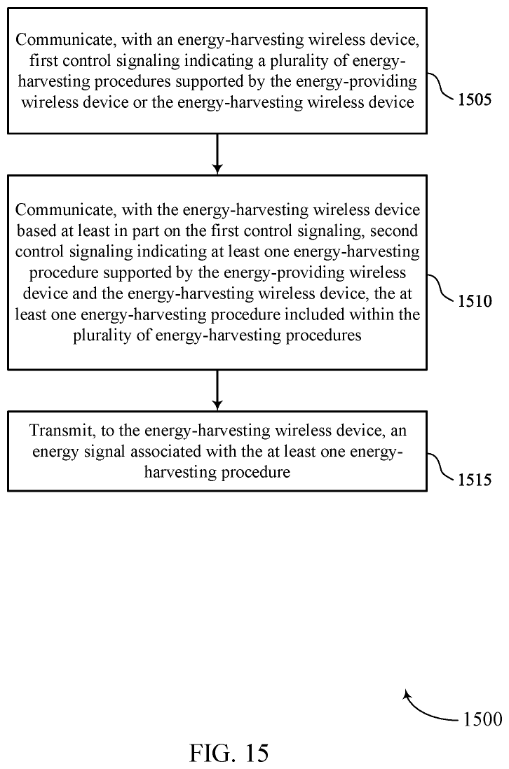

FIG. 15 shows a flowchart illustrating a method 1500 that supports techniques for energy transfer devices supporting multiple types of wireless energy transfer in accordance with one or more aspects of the present disclosure. The operations of the method 1500 may be implemented by an energy-providing device, such as a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method includes communicating, with an energy-harvesting wireless device, first control signaling indicating a set of multiple energy-harvesting procedures supported by the energy-providing wireless device or the energy-harvesting wireless device. The operations of 1505 may be performed in accordance with examples as disclosed herein. In some examples, aspects of the operations of 1505 may be performed by a control signaling communications manager 925 as described with reference to FIG. 9 and/or a control signaling communications manager 1025 as described with reference to FIG. 10.

At 1510, the method includes communicating, with the energy-harvesting wireless device based on the first control signaling, second control signaling indicating at least one energy-harvesting procedure supported by the energy-providing wireless device and the energy-harvesting wireless device, the at least one energy-harvesting procedure included within the set of multiple energy-harvesting procedures. The operations of 1510 may be performed in accordance with examples as disclosed herein. In some examples, aspects of the operations of 1510 may be performed by a control signaling communications manager 925 as described with reference to FIG. 9 and/or a control signaling communications manager 1025 as described with reference to FIG. 10.

At 1515, the method includes transmitting, to the energy-harvesting wireless device, an energy signal associated with the at least one energy-harvesting procedure. The operations of 1515 may be performed in accordance with examples as disclosed herein. In some examples, aspects of the operations of 1515 may be performed by an energy signal transmitting manager 930 as described with reference to FIG. 9 an energy signal transmitting manager 1030 as described with reference to FIG. 10.

The following provides an overview of aspects of the present disclosure:

Aspect 1: A method for wireless communication at an energy-harvesting wireless device, comprising: communicating, with an energy-providing wireless device, first control signaling indicating a plurality of energy-harvesting procedures supported by the energy-providing wireless device or the energy-harvesting wireless device; communicating, with the energy-providing wireless device based at least in part on the first control signaling, second control signaling indicating at least one energy-harvesting procedure supported by the energy-providing wireless device and the energy-harvesting wireless device, the at least one energy-harvesting procedure included within the plurality of energy-harvesting procedures; and receiving, from the energy-providing wireless device, an energy signal associated with the at least one energy-harvesting procedure.

Aspect 2: The method of aspect 1, further comprising: communicating, with the energy-providing wireless device, the first control signaling indicating an energy-harvesting pattern associated with the energy-providing wireless device or the energy-harvesting wireless device, wherein the energy signal is received within a time interval of a plurality of time intervals of the energy-harvesting pattern.

Aspect 3: The method of any of aspects 1 through 2, further comprising: transmitting, to the energy-providing wireless device, the first control signaling indicating one or more parameters associated with at least one of the plurality of energy-harvesting procedures supported by the energy-harvesting wireless device, the one or more parameters indicating an energy efficiency, a charging rate, or both, wherein the second control signaling is received based at least in part on the one or more parameters.

Aspect 4: The method of any of aspects 1 through 3, further comprising: receiving, from the energy-providing wireless device, the second control signaling or additional control signaling indicating a set of resources usable for performing the at least one energy-harvesting procedure, wherein the energy signal is received within the set of resources.

Aspect 5: The method of any of aspects 1 through 4, further comprising: receiving, from the energy-providing wireless device, the second control signaling or additional control signaling indicating a QCL indicator, a TCI state, a TRP associated with the energy-providing wireless device, or any combination thereof, wherein receiving the energy signal is based at least in part on the QCL indicator, the TCI state, the TRP, or any combination thereof.

Aspect 6: The method of any of aspects 1 through 5, further comprising: receiving a first QCL indicator and a second QCL indicator associated with a first TRP and a second TRP, respectively, associated with the energy-providing wireless device: receiving the energy signal associated with the at least one energy-harvesting procedure via the first TRP and in accordance with the first QCL indicator; and receiving an additional energy signal associated with the at least one energy-harvesting procedure via the second TRP and in accordance with the second QCL indicator.

Aspect 7: The method of any of aspects 1 through 6, further comprising: communicating, with the energy-providing wireless device, a request for the plurality of energy-harvesting procedures supported by the energy-providing wireless device or the energy-harvesting wireless device, wherein communicating the first control signaling, the second control signaling, or both, is based at least in part on the request.

Aspect 8: The method of any of aspects 1 through 7, wherein the energy signal is received during a first time interval, the method further comprising: communicating, with the energy-providing wireless device, a capability indication that the energy-harvesting wireless device is capable of performing multiple temporally-overlapping energy-harvesting procedures; and receiving, from the energy-providing wireless device, a second energy signal associated with an additional energy-harvesting procedure based at least in part on the capability indication, wherein the second energy signal is received during a second time interval that at least partially overlaps in a time domain with the first time interval.

Aspect 9: The method of any of aspects 1 through 8, further comprising: transmitting, to the energy-providing wireless device based at least in part on receiving the energy signal, a report indicating one or more parameters associated with the at least one energy-harvesting procedure.

Aspect 10: The method of aspect 9, further comprising: receiving, from the energy-providing wireless device, a reporting configuration for transmitting reports associated with energy-harvesting procedures, wherein the report is transmitted in accordance with the reporting configuration.

Aspect 11: The method of any of aspects 9 through 10, further comprising: receiving, from the energy-providing wireless device based at least in part on transmitting the report, an instruction to selectively adjust one or more reception parameters for receiving energy signals associated with the at least one energy-harvesting procedure; and receiving an additional energy signal associated with the at least one energy-harvesting procedure based at least in part on the instruction.

Aspect 12: The method of any of aspects 1 through 11, further comprising: receiving additional control signaling indicating a plurality of energy-harvesting types, wherein each energy-harvesting type supports a respective set of energy-harvesting procedures; and communicating, via the first control signaling, an indication of an energy-harvesting type associated with the energy-harvesting wireless device, wherein communicating the second control signaling, receiving the energy signal, or both, is based at least in part on the energy-harvesting type.

Aspect 13: The method of any of aspects 1 through 12, further comprising: communicating, with the energy-providing wireless device, third control signaling indicating that one or more energy-harvesting procedures of the plurality of energy-harvesting procedures is no longer supported by the energy-providing wireless device or the energy-harvesting wireless device for a time interval.

Aspect 14: The method of any of aspects 1 through 13, further comprising: transmitting, to the energy-providing wireless device, the first control signaling indicating the plurality of energy-harvesting procedures supported by the energy-harvesting wireless device; and receiving, from the energy-providing wireless device, the second control signaling indicating the at least one energy-harvesting procedure supported by the energy-providing wireless device.

Aspect 15: The method of any of aspects 1 through 3, further comprising: receiving, from the energy-providing wireless device, the first control signaling indicating the plurality of energy-harvesting procedures supported by the energy-providing wireless device; and transmitting, to the energy-providing wireless device, the second control signaling indicating the at least one energy-harvesting procedure supported by the energy-harvesting wireless device.

Aspect 16: The method of any of aspects 1 through 15, wherein the plurality of energy-harvesting procedures comprise a first energy-harvesting procedure and a second energy-harvesting procedure, the method further comprising: transmitting, to the energy-harvesting wireless device via the first control signaling or the second control signaling, a first energy storage capacity associated with the first energy-harvesting procedure, a second energy storage capacity associated with the second energy-harvesting procedure, a third energy storage capacity associated with both the first energy-harvesting procedure and the second energy-harvesting procedure, or any combination thereof, wherein receiving the energy signal is based at least in part on the first energy storage capacity, the second energy storage capacity, the third energy storage capacity, or any combination thereof.

Aspect 17: The method of any of aspects 1 through 16, further comprising: receiving a WUS from the energy-providing wireless device, wherein receiving the energy signal is based at least in part on receiving the WUS.

Aspect 18: The method of any of aspects 1 through 17, further comprising: generating energy based at least in part on receiving the energy signal; and performing one or more communications or other operations using the generated energy, storing the generated energy in an energy storage component, or both.

Aspect 19: The method of any of aspects 1 through 18, wherein the plurality of energy-harvesting procedures comprises an RF-based energy-harvesting procedure, a light-based energy-harvesting procedure, a motion-based energy-harvesting procedure, a heat-based energy-harvesting procedure, or any combination thereof.

Aspect 20: The method of any of aspects 1 through 19, wherein the energy-harvesting wireless device comprises a UE, and the energy-providing wireless device comprises a network entity.

Aspect 21: A method for wireless communication at an energy-providing wireless device, comprising: communicating, with an energy-harvesting wireless device, first control signaling indicating a plurality of energy-harvesting procedures supported by the energy-providing wireless device or the energy-harvesting wireless device: communicating, with the energy-harvesting wireless device based at least in part on the first control signaling, second control signaling indicating at least one energy-harvesting procedure supported by the energy-providing wireless device and the energy-harvesting wireless device, the at least one energy-harvesting procedure included within the plurality of energy-harvesting procedures; and transmitting, to the energy-harvesting wireless device, an energy signal associated with the at least one energy-harvesting procedure.

Aspect 22: The method of aspect 21, further comprising: communicating, with the energy-harvesting wireless device, the first control signaling indicating an energy-harvesting pattern associated with the energy-providing wireless device or the energy-harvesting wireless device, wherein the energy signal is transmitted within a time interval of a plurality of time intervals of the energy-harvesting pattern.

Aspect 23: The method of any of aspects 21 through 22, further comprising: receiving, from the energy-harvesting wireless device, the first control signaling indicating one or more parameters associated with at least one of the plurality of energy-harvesting procedures supported by the energy-harvesting wireless device, the one or more parameters indicating an energy efficiency, a charging rate, or both; and selecting the at least one energy-harvesting procedure from the plurality of energy-harvesting procedures based at least in part on the one or more parameters, wherein the second control signaling is transmitted based at least in part on the selecting.

Aspect 24: The method of any of aspects 21 through 23, further comprising: transmitting, to the energy-harvesting wireless device, the second control signaling or additional control signaling indicating a set of resources usable for performing the at least one energy-harvesting procedure, wherein the energy signal is transmitted within the set of resources.

Aspect 25: The method of any of aspects 21 through 24, further comprising: transmitting, to the energy-harvesting wireless device, the second control signaling or additional control signaling indicating a QCL indicator, a TCI state, a TRP associated with the energy-providing wireless device, or any combination thereof, wherein transmitting the energy signal is based at least in part on the QCL indicator, the TCI state, the TRP, or any combination thereof.

Aspect 26: The method of any of aspects 21 through 25, further comprising: communicating, with the energy-harvesting wireless device, a request for the plurality of energy-harvesting procedures supported by the energy-providing wireless device or the energy-harvesting wireless device, wherein communicating the first control signaling, the second control signaling, or both, is based at least in part on the request.

Aspect 27: The method of any of aspects 21 through 26, wherein the energy signal is transmitted during a first time interval, the method further comprising: communicating, with the energy-harvesting wireless device, a capability indication that the energy-harvesting wireless device is capable of performing multiple temporally-overlapping energy-harvesting procedures; and transmitting, to the energy-harvesting wireless device, a second energy signal associated with an additional energy-harvesting procedure based at least in part on the capability indication, wherein the second energy signal is transmitted during a second time interval that at least partially overlaps in a time domain with the first time interval.

Aspect 28: The method of any of aspects 21 through 27, further comprising: receiving, from the energy-harvesting wireless device based at least in part on transmitting the energy signal, a report indicating one or more parameters associated with the at least one energy-harvesting procedure.

Aspect 29: The method of aspect 28, further comprising: transmitting, to the energy-harvesting wireless device, a reporting configuration for transmitting reports associated with energy-harvesting procedures, wherein the report is received in accordance with the reporting configuration.

Aspect 30: The method of any of aspects 28 through 29, further comprising: transmitting, to the energy-harvesting wireless device based at least in part on receiving the report, an instruction to selectively adjust one or more reception parameters for receiving energy signals associated with the at least one energy-harvesting procedure; and transmitting an additional energy signal associated with the at least one energy-harvesting procedure based at least in part on the instruction.

Aspect 31: The method of any of aspects 28 through 30, further comprising: selectively adjusting one or more transmission parameters for transmitting energy signals based at least in part on the report; and transmitting an additional energy signal associated with the at least one energy-harvesting procedure based at least in part on selectively adjusting the one or more transmission parameters.

Aspect 32: The method of any of aspects 21 through 31, further comprising: communicating, with the energy-harvesting wireless device, third control signaling indicating that one or more energy-harvesting procedures of the plurality of energy-harvesting procedures is no longer supported by the energy-providing wireless device or the energy-harvesting wireless device for a time interval.

Aspect 33: The method of any of aspects 21 through 32, further comprising: transmitting a WUS to the energy-harvesting wireless device, wherein transmitting the energy signal is based at least in part on transmitting the WUS.

Aspect 34: The method of any of aspects 21 through 33, wherein the plurality of energy-harvesting procedures comprises an RF-based energy-harvesting procedure, a light-based energy-harvesting procedure, a motion-based energy-harvesting procedure, a heat-based energy-harvesting procedure, or any combination thereof.

Aspect 35: The method of any of aspects 21 through 34, wherein the energy-harvesting wireless device comprises a UE, and the energy-providing wireless device comprises a network entity.

Aspect 36: An apparatus for wireless communication at an energy-harvesting wireless device, comprising a processor: memory coupled with the processor; and instructions stored in the memory and executable by the processor to cause the apparatus to perform a method of any of aspects 1 through 20.

Aspect 37: An apparatus for wireless communication at an energy-harvesting wireless device, comprising at least one means for performing a method of any of aspects 1 through 20.

Aspect 38: A non-transitory computer-readable medium storing code for wireless communication at an energy-harvesting wireless device, the code comprising instructions executable by a processor to perform a method of any of aspects 1 through 20.

Aspect 39: An apparatus for wireless communication at an energy-providing wireless device, comprising a processor: memory coupled with the processor; and instructions stored in the memory and executable by the processor to cause the apparatus to perform a method of any of aspects 21 through 35.

Aspect 40: An apparatus for wireless communication at an energy-providing wireless device, comprising at least one means for performing a method of any of aspects 21 through 35.

Aspect 41: A non-transitory computer-readable medium storing code for wireless communication at an energy-providing wireless device, the code comprising instructions executable by a processor to perform a method of any of aspects 21 through 35.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone: B alone: C alone: A and B in combination; A and C in combination; B and C in combination: or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at an energy-harvesting wireless device, comprising:
one or more processors;
one or more memories coupled with the one or more processors; and
instructions stored in the one or more memories and executable by the one or more processors, individually or collectively, to cause the apparatus to:
communicate, with an energy-providing wireless device, first control signaling indicating a plurality of energy-harvesting procedures supported by the energy-providing wireless device or the energy-harvesting wireless device;
communicate, with the energy-providing wireless device based at least in part on the first control signaling, second control signaling indicating at least one energy-harvesting procedure supported by the energy-providing wireless device and the energy-harvesting wireless device, the at least one energy-harvesting procedure included within the plurality of energy-harvesting procedures; and
receive, from the energy-providing wireless device, an energy signal associated with the at least one energy-harvesting procedure.

2. The apparatus of claim 1, wherein the instructions are further executable by the one or more processors, individually or collectively, to cause the apparatus to:
communicate, with the energy-providing wireless device, the first control signaling indicating an energy-harvesting pattern associated with the energy-providing wireless device or the energy-harvesting wireless device, wherein the energy signal is received within a time interval of a plurality of time intervals of the energy-harvesting pattern.

3. The apparatus of claim 1, wherein the instructions are further executable by the one or more processors, individually or collectively, to cause the apparatus to:
transmit, to the energy-providing wireless device, the first control signaling indicating one or more parameters associated with at least one of the plurality of energy-harvesting procedures supported by the energy-harvesting wireless device, the one or more parameters indicating an energy efficiency, a charging rate, or both, wherein the second control signaling is received based at least in part on the one or more parameters.

4. The apparatus of claim 1, wherein the instructions are further executable by the one or more processors, individually or collectively, to cause the apparatus to:
receive, from the energy-providing wireless device, the second control signaling or additional control signaling indicating a set of resources usable for performing the at least one energy-harvesting procedure, wherein the energy signal is received within the set of resources.

5. The apparatus of claim 1, wherein the instructions are further executable by the one or more processors, individually or collectively, to cause the apparatus to:
receive, from the energy-providing wireless device, the second control signaling or additional control signaling indicating a quasi co-location indicator, a transmission configuration indicator state, a transmission-reception point associated with the energy-providing wireless device, or any combination thereof, wherein receiving the energy signal is based at least in part on the quasi co-location indicator, the transmission configuration indicator state, the transmission-reception point, or any combination thereof.

6. The apparatus of claim 1, wherein the instructions are further executable by the one or more processors, individually or collectively, to cause the apparatus to:
receive a first quasi co-location indicator and a second quasi co-location indicator associated with a first transmission-reception point and a second transmission-reception point, respectively, associated with the energy-providing wireless device;
receive the energy signal associated with the at least one energy-harvesting procedure via the first transmission-reception point and in accordance with the first quasi co-location indicator; and
receive an additional energy signal associated with the at least one energy-harvesting procedure via the second transmission-reception point and in accordance with the second quasi co-location indicator.

7. The apparatus of claim 1, wherein the instructions are further executable by the one or more processors, individually or collectively, to cause the apparatus to:
communicate, with the energy-providing wireless device, a request for the plurality of energy-harvesting procedures supported by the energy-providing wireless device or the energy-harvesting wireless device, wherein communicating the first control signaling, the second control signaling, or both, is based at least in part on the request.

8. The apparatus of claim 1, wherein the energy signal is received during a first time interval, and the instructions are further executable by the one or more processors, individually or collectively, to cause the apparatus to:
communicate, with the energy-providing wireless device, a capability indication that the energy-harvesting wireless device is capable of performing multiple temporally-overlapping energy-harvesting procedures; and
receive, from the energy-providing wireless device, a second energy signal associated with an additional energy-harvesting procedure based at least in part on the capability indication, wherein the second energy signal is received during a second time interval that at least partially overlaps in a time domain with the first time interval.

9. The apparatus of claim 1, wherein the instructions are further executable by the one or more processors, individually or collectively, to cause the apparatus to:
transmit, to the energy-providing wireless device based at least in part on receiving the energy signal, a report indicating one or more parameters associated with the at least one energy-harvesting procedure.

10. The apparatus of claim 9, wherein the instructions are further executable by the one or more processors, individually or collectively, to cause the apparatus to:
receive, from the energy-providing wireless device, a reporting configuration for transmitting reports associated with energy-harvesting procedures, wherein the report is transmitted in accordance with the reporting configuration.

11. The apparatus of claim 9, wherein the instructions are further executable by the one or more processors, individually or collectively, to cause the apparatus to:
receive, from the energy-providing wireless device based at least in part on transmitting the report, an instruction to selectively adjust one or more reception parameters for receiving energy signals associated with the at least one energy-harvesting procedure; and
receive an additional energy signal associated with the at least one energy-harvesting procedure based at least in part on the instruction.

12. The apparatus of claim 1, wherein the instructions are further executable by the one or more processors, individually or collectively, to cause the apparatus to:
receive additional control signaling indicating a plurality of energy-harvesting types, wherein each energy-harvesting type supports a respective set of energy-harvesting procedures; and
communicate, via the first control signaling, an indication of an energy-harvesting type associated with the energy-harvesting wireless device, wherein communicating the second control signaling, receiving the energy signal, or both, is based at least in part on the energy-harvesting type.

13. The apparatus of claim 1, wherein the instructions are further executable by the one or more processors, individually or collectively, to cause the apparatus to:
communicate, with the energy-providing wireless device, third control signaling indicating that one or more energy-harvesting procedures of the plurality of energy-harvesting procedures is no longer supported by the energy-providing wireless device or the energy-harvesting wireless device for a time interval.

14. The apparatus of claim 1, wherein the instructions are further executable by the one or more processors, individually or collectively, to cause the apparatus to:
transmit, to the energy-providing wireless device, the first control signaling indicating the plurality of energy-harvesting procedures supported by the energy-harvesting wireless device; and
receive, from the energy-providing wireless device, the second control signaling indicating the at least one energy-harvesting procedure supported by the energy-providing wireless device.

15. The apparatus of claim 1, wherein the instructions are further executable by the one or more processors, individually or collectively, to cause the apparatus to:
receive, from the energy-providing wireless device, the first control signaling indicating the plurality of energy-harvesting procedures supported by the energy-providing wireless device; and
transmit, to the energy-providing wireless device, the second control signaling indicating the at least one energy-harvesting procedure supported by the energy-harvesting wireless device.

16. The apparatus of claim 1, wherein the plurality of energy-harvesting procedures comprise a first energy-harvesting procedure and a second energy-harvesting procedure, and the instructions are further executable by the one or more processors, individually or collectively, to cause the apparatus to:
transmit, to the energy-harvesting wireless device via the first control signaling or the second control signaling, a first energy storage capacity associated with the first energy-harvesting procedure, a second energy storage capacity associated with the second energy-harvesting procedure, a third energy storage capacity associated with both the first energy-harvesting procedure and the second energy-harvesting procedure, or any combination thereof, wherein receiving the energy signal is based at least in part on the first energy storage capacity, the second energy storage capacity, the third energy storage capacity, or any combination thereof.

17. The apparatus of claim 1, wherein the instructions are further executable by the one or more processors, individually or collectively, to cause the apparatus to:
receive a wake-up signal from the energy-providing wireless device, wherein receiving the energy signal is based at least in part on receiving the wake-up signal.

18. The apparatus of claim 1, wherein the instructions are further executable by the one or more processors, individually or collectively, to cause the apparatus to:
generate energy based at least in part on receiving the energy signal; and
perform one or more communications or other operations using the generated energy, storing the generated energy in an energy storage component, or both.

19. The apparatus of claim 1, wherein the plurality of energy-harvesting procedures comprises a radio frequency-based energy-harvesting procedure, a light-based energy-harvesting procedure, a motion-based energy-harvesting procedure, a heat-based energy-harvesting procedure, or any combination thereof.

20. (canceled)

21. An apparatus for wireless communication at an energy-providing wireless device, comprising:
one or more processors;
one or more memories coupled with the one or more processors; and
instructions stored in the one or more memories and executable by the one or more processors, individually or collectively, to cause the apparatus to:
communicate, with an energy-harvesting wireless device, first control signaling indicating a plurality of energy-harvesting procedures supported by the energy-providing wireless device or the energy-harvesting wireless device;
communicate, with the energy-harvesting wireless device based at least in part on the first control signaling, second control signaling indicating at least one energy-harvesting procedure supported by the energy-providing wireless device and the energy-harvesting wireless device, the at least one energy-harvesting procedure included within the plurality of energy-harvesting procedures; and
transmit, to the energy-harvesting wireless device, an energy signal associated with the at least one energy-harvesting procedure.

22-30. (canceled)
